(19) United States
(12) Patent Application Publication
(10) Pub. No.: US 2026/0228925 A1
(43) Pub. Date: Aug. 6, 2026

(54) Inverse Quantization Adjustment for 3D Mesh Displacements

(71) Applicant: Ofinno, LLC, Reston, VA (US)

(72) Inventor: Chao Cao, Centreville, VA (US)

(73) Assignee: Ofinno, LLC, Reston, VA (US)

(21) Appl. No.: 19/636,576

(22) Filed: Apr. 1, 2026

Related U.S. Application Data
(63) Continuation of application No. PCT/US2024/050761, filed on Oct. 10, 2024.
(60) Provisional application No. 63/543,730, filed on Oct. 11, 2023.
(60) Provisional application No. 63/621,339, filed on Jan. 16, 2024.

(51) Int. Cl. G06T 9/00; G06T 17/20

(52) U.S. Cl. CPC G06T 9/001; G06T 17/20; G06T 2210/36

(57) ABSTRACT

A decoder decodes, from a bitstream, a quantized wavelet coefficient representing a displacement of a vertex in a set of vertices of a three-dimensional (3D) mesh and decodes from the bitstream, quantization information indicating a quantization offset associated with a subset of vertices of the set of vertices. The decoder further inverse quantizes the quantized wavelet coefficient to determine a wavelet coefficient and adjusts, based on the vertex being in the subset, the wavelet coefficient according to the quantization offset to determine the displacement of the vertex.

### CROSS-REFERENCE TO RELATED APPLICATIONS

This application is a continuation of International Application No. PCT/US2024/050761, filed Oct. 10, 2024, which claims the benefit of U.S. Provisional Application Nos. 63/543,730, filed Oct. 11, 2023, and 63/621,339, filed Jan. 16, 2024, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates an exemplary mesh coding/decoding system in which embodiments of the present disclosure may be implemented.

FIG. 2A illustrates a block diagram of an example encoder for intra encoding a 3D mesh, according to some embodiments.

FIG. 2B illustrates a block diagram of an example encoder for inter encoding a 3D mesh, according to some embodiments.

FIG. 3 illustrates a diagram showing an example decoder.

FIG. 4 is a diagram showing an example process for generating displacements of an input mesh (e.g., an input 3D mesh frame) to be encoded, according to some embodiments.

FIG. 5 illustrates an example process for approximating and encoding a geometry of a 3D mesh, according to some embodiments.

FIG. 6 illustrates an example of vertices of a subdivided mesh (e.g., a subdivided base mesh) corresponding to multiple levels of detail (LODs), according to some embodiments.

FIG. 7A illustrates an example of an image packed with displacements (e.g., displacement fields or vectors) using a packing method, according to some embodiments.

FIG. 7B illustrates an example of the displacement image with labeled LODs, according to some embodiments.

FIG. 8 illustrates an example of a quantizer to quantize transformed wavelet coefficients representing displacements of a 3D mesh, according to some embodiments.

FIG. 9 illustrates an example of an inverse quantizer to inverse quantize quantized-transformed wavelet coefficients representing displacements of a 3D mesh, according to some embodiments.

FIG. 10 illustrates an example of an inverse quantizer with a quantization offset to inverse quantize quantized-transformed wavelet coefficients representing displacements of a 3D mesh, according to some embodiments.

FIG. 11A is a diagram that illustrates an example process for iteratively inverse quantizing quantized-transformed wavelet coefficients of vertices in each subset of vertices of the 3D mesh, according to some embodiments.

FIG. 11B is a diagram that illustrates an example process for iteratively inverse quantizing quantized-transformed wavelet coefficients of vertices in each subset of vertices of the 3D mesh, according to some embodiments.

FIG. 12 illustrates a flowchart of a method for applying a quantization scheme to transformed wavelet coefficients, according to some embodiments.

FIG. 13 illustrates a flowchart of a method for applying an inverse quantization scheme to quantized-transformed wavelet coefficients, according to some embodiments.

FIG. 14 illustrates a block diagram of an exemplary computer system in which embodiments of the present disclosure may be implemented.

### DETAILED DESCRIPTION

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

Traditional visual data describes an object or scene using a series of pixels that each comprise a position in two dimensions (x and y) and one or more optional attributes like color. Volumetric visual data adds another positional dimension to this traditional visual data. Volumetric visual data describes an object or scene using a series of points that each comprise a position in three dimensions (x, y, and z) and one or more optional attributes like color. Compared to traditional visual data, volumetric visual data may provide a more immersive way to experience visual data. For example, an object or scene described by volumetric visual data may be viewed from any (or multiple) angles, whereas traditional visual data may generally only be viewed from the angle in which it was captured or rendered. Volumetric visual data may be used in many applications, including Augmented Reality (AR), Virtual Reality (VR), and Mixed Reality (MR). Volumetric visual data may be in the form of a volumetric frame that describes an object or scene captured at a particular time instance or in the form of a sequence of volumetric frames (referred to as a volumetric sequence or volumetric video) that describes an object or scene captured at multiple different time instances.

One format for storing volumetric visual data is three dimensional (3D) meshes (hereinafter referred to as a mesh or a mesh frame). A mesh frame (or mesh) comprises a collection of points in three-dimensional (3D) space, also referred to as vertices. Each vertex in a mesh comprises geometry information that indicates the vertex's position in 3D space. For example, the geometry information may indicate the vertex's position in 3D space using three Cartesian coordinates (x, y, and z). Further the mesh may comprise geometry information indicating a plurality of triangles. Each triangle comprises three vertices connected by three edges and a face. One or more types of attribute information may be stored for each face (of a triangle). Attribute information may indicate a property of a face's visual appearance. For example, attribute information may indicate a texture (e.g., color) of the face, a material type of the face, transparency information of the face, reflectance information of the face, a normal vector to a surface of the face, a velocity at the face, an acceleration at the face, a time stamp indicating when the face (and/or vertex) was captured, or a modality indicating how the face (and/or vertex) was captured (e.g., running, walking, or flying). In another example, a face (or vertex) may comprise light field data in the form of multiple view-dependent texture information. Light field data may be another type of optional attribute information.

The triangles (e.g., represented by vertexes and edges) in a mesh may describe an object or a scene. For example, the triangles in a mesh may describe the external surface and/or the internal structure of an object or scene. The object or scene may be synthetically generated by a computer or may be generated from the capture of a real-world object or scene. The geometry information of a real world object or scene may be obtained by 3D scanning and/or photogrammetry. 3D scanning may include laser scanning, structured light scanning, and/or modulated light scanning. 3D scanning may obtain geometry information by moving one or more laser heads, structured light cameras, and/or modulated light cameras relative to an object or scene being scanned. Photogrammetry may obtain geometry information by triangulating the same feature or point in different spatially shifted 2D photographs. Mesh data may be in the form of a mesh frame that describes an object or scene captured at a particular time instance or in the form of a sequence of mesh frames (referred to as a mesh sequence or mesh video) that describes an object or scene captured at multiple different time instances.

The data size of a mesh frame or sequence in addition with one or more types of attribute information may be too large for storage and/or transmission in many applications. For example, a single mesh frame may comprise thousands or tens or hundreds of thousands of triangles, where each triangle (e.g., vertexes and/or edges) comprises geometry information and one or more optional types of attribute information. The geometry information of each vertex may comprise three Cartesian coordinates (x, y, and z) that are each represented, for example, using 8 bits or 24 bits in total. The attribute information of each point may comprise a texture corresponding to three color components (e.g., R, G, and B color components) that are each represented, for example, using 8 bits or 24 bits in total. A single vertex therefore comprises 48 bits of information in this example, with 24 bits of geometry information and 24 bits of texture. Encoding may be used to compress the size of a mesh frame or sequence to provide for more efficient storage and/or transmission. Decoding may be used to decompress a compressed mesh frame or sequence for display and/or other forms of consumption (e.g., by a machine learning based device, neural network based device, artificial intelligence based device, or other forms of consumption by other types of machine based processing algorithms and/or devices).

Compression of meshes may be lossy (e.g., introducing differences relative to the original data) for the distribution to and visualization by an end-user, for example on AR/VR glasses or any other 3D-capable device. Lossy compression allows for a very high ratio of compression but incurs a trade-off between compression and visual quality perceived by the end-user. Other frameworks, like medical or geological applications, may require lossless compression to avoid altering the decompressed meshes.

Volumetric visual data may be stored after being encoded into a bitstream in a container, for example, a file server in the network. The end-user may request for a specific bitstream depending on the user's requirement. The user may also request for adaptive streaming of the bitstream where the trade-off between network resource consumption and visual quality perceived by the end-user is taken into consideration by an algorithm.

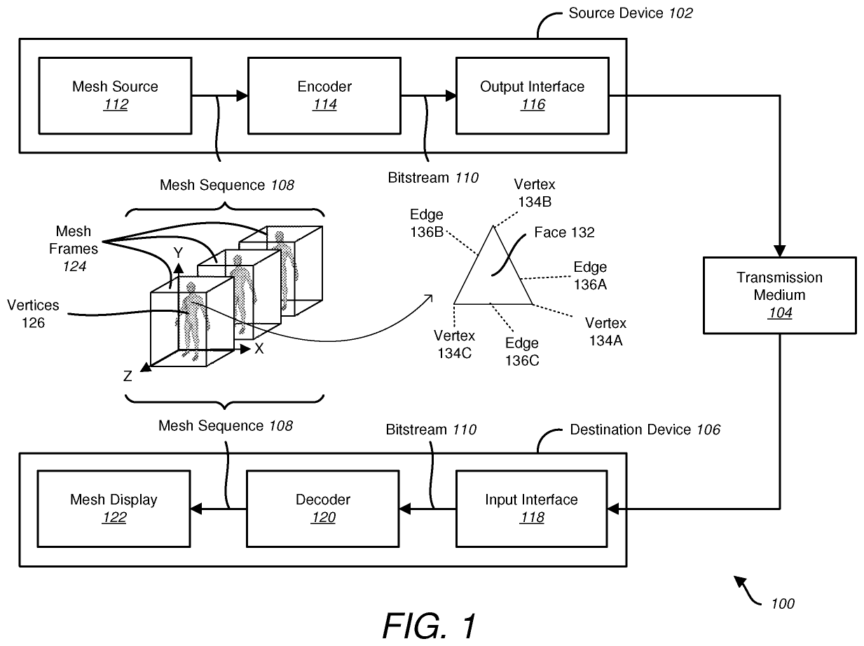

FIG. 1 illustrates an exemplary mesh coding/decoding system 100 in which embodiments of the present disclosure may be implemented. Mesh coding/decoding system 100 comprises a source device 102, a transmission medium 104, and a destination device 106. Source device 102 encodes a mesh sequence 108 into a bitstream 110 for more efficient storage and/or transmission. Source device 102 may store and/or transmit bitstream 110 to destination device 106 via transmission medium 104. Destination device 106 decodes bitstream 110 to display mesh sequence 108 or for other forms of consumption. Destination device 106 may receive bitstream 110 from source device 102 via a storage medium or transmission medium 104. Source device 102 and destination device 106 may be any one of a number of different devices, including a cluster of interconnected computer systems acting as a pool of seamless resources (also referred to as a cloud of computers or cloud computer), a server, a desktop computer, a laptop computer, a tablet computer, a smart phone, a wearable device, a television, a camera, a video gaming console, a set-top box, a video streaming device, an autonomous vehicle, or a head mounted display. A head mounted display may allow a user to view a VR, AR, or MR scene and adjust the view of the scene based on movement of the user's head. A head mounted display may be tethered to a processing device (e.g., a server, desktop computer, set-top box, or video gaming counsel) or may be fully self-contained.

To encode mesh sequence 108 into bitstream 110, source device 102 may comprise a mesh source 112, an encoder 114, and an output interface 116. Mesh source 112 may provide or generate mesh sequence 108 from a capture of a natural scene and/or a synthetically generated scene. A synthetically generated scene may be a scene comprising computer generated graphics. Mesh source 112 may comprise one or more mesh capture devices (e.g., one or more laser scanning devices, structured light scanning devices, modulated light scanning devices, and/or passive scanning devices), a mesh archive comprising previously captured natural scenes and/or synthetically generated scenes, a mesh feed interface to receive captured natural scenes and/or synthetically generated scenes from a mesh content provider, and/or a processor to generate synthetic mesh scenes.

As shown in FIG. 1, a mesh sequence 108 may comprise a series of mesh frames 124. A mesh frame describes an object or scene captured at a particular time instance. Mesh sequence 108 may achieve the impression of motion when a constant or variable time is used to successively present mesh frames 124 of mesh sequence 108. A (3D) mesh frame comprises a collection of vertices 126 in 3D space and geometry information of vertices 126. A 3D mesh may comprise a collection of vertices, edges, and faces that define the shape of a polyhedral object. Further, the mesh frame comprises a plurality of triangles (e.g., polygon triangles). For example, a triangle may include vertices 134A-C and edges 136A-C and a face 132. The faces usually consist of triangles (triangle mesh), Quadrilaterals (Quads), or other simple convex polygons (n-gons), since this simplifies rendering, but may also be more generally composed of concave polygons, or even polygons with holes. Each of vertices 126 may comprise geometry information that indicates the point's position in 3D space. For example, the geometry information may indicate the point's position in 3D space using three Cartesian coordinates (x, y, and z). For example, the geometry information may indicated the plurality of triangles with each comprising three vertices of vertices 126. One or more of the triangles may further comprise one or more types of attribute information. Attribute information may indicate a property of a point's visual appearance. For example, attribute information may indicate a texture (e.g., color) of a face, a material type of a face, transparency information of a face, reflectance information of a face, a normal vector to a surface of a face, a velocity at a face, an acceleration at a face, a time stamp indicating when a face was captured, a modality indicating when a face was captured (e.g., running, walking, or flying). In another example, one or more of the faces (or triangles) may comprise light field data in the form of multiple view-dependent texture information. Light field data may be another type of optional attribute information. Color attribute information of one or more of the faces may comprise a luminance value and two chrominance values. The luminance value may represent the brightness (or luma component, Y) of the point. The chrominance values may respectively represent the blue and red components of the point (or chroma components, Cb and Cr) separate from the brightness. Other color attribute values are possible based on different color schemes (e.g., an RGB or monochrome color scheme).

In some embodiments, a 3D mesh (e.g., one of mesh frames 124) may be a static or a dynamic mesh. In some examples, the 3D mesh may be represented (e.g., defined) by connectivity information, geometry information, and texture information (e.g., texture coordinates and texture connectivity). In some embodiments, the geometry information may represent locations of vertices of the 3D mesh in 3D space and the connectivity information may indicate how the vertices are to be connected together to form polygons (e.g., triangles) that make up the 3D mesh. Also, the texture coordinates indicate locations of pixels in a 2D image that correspond to vertices of a corresponding 3D mesh (or a sub-mesh of the 3D mesh). In some examples, patch information may indicate how the texture coordinates defined with respect to a 2D bounding box map into a 3D space of a 3D bounding box associated with the patch based on how the points were projected onto a projection plane for the patch. Also, the texture connectivity information may indicate how the vertices represented by the texture coordinates are to be connected together to form polygons of the 3D mesh (or sub-meshes). For example, each texture or attribute patch of the texture image may corresponds to a corresponding sub-mesh defined using texture coordinates and texture connectivity.

In some embodiments, for each 3D mesh, one or multiple 2D images may represent the textures or attributes associated with the mesh. For example, the texture information may include geometry information listed as X, Y, and Z coordinates of vertices and texture coordinates listed as 2D dimensional coordinates corresponding to the vertices. The example texture mesh may include texture connectivity information that indicates mappings between the geometry coordinates and texture coordinates to form polygons, such as triangles. For example, a first triangle may be formed by three vertices, where a first vertex is defined as the first geometry coordinate (e.g. 64.062500, 1237.739990, 51.757801), which corresponds with the first texture coordinate (e.g. 0.0897381, 0.740830). A second vertex of the triangle may be defined as the second geometry coordinate (e.g. 59.570301, 1236.819946, 54.899700), which corresponds with the second texture coordinate (e.g. 0.899059, 0.741542). Finally, a third vertex of the triangle may correspond to the third listed geometry coordinate which matches with the third listed texture coordinate. However, note that in some instances a vertex of a polygon, such as a triangle may map to a set of geometry coordinates and texture coordinates that may have different index positions in the respective lists of geometry coordinates and texture coordinates. For example, the second triangle has a first vertex corresponding to the fourth listed set of geometry coordinates and the seventh listed set of texture coordinates. A second vertex corresponding to the first listed set of geometry coordinates and the first set of listed texture coordinates and a third vertex corresponding to the third listed set of geometry coordinates and the ninth listed set of texture coordinates.

Encoder 114 may encode mesh sequence 108 into bitstream 110. To encode mesh sequence 108, encoder 114 may apply one or more prediction techniques to reduce redundant information in mesh sequence 108. Redundant information is information that may be predicted at a decoder and therefore may not be needed to be transmitted to the decoder for accurate decoding of mesh sequence 108. For example, encoder 114 may convert attribute information (e.g., texture information) of one or more of mesh frames 124 from 3D to 2D and then apply one or more 2D video encoders or encoding methods to the 2D images. For example, any one of multiple different proprietary or standardized 2D video encoders/decoders may be used, including International Telecommunications Union Telecommunication Standardization Sector (ITU-T) H.1263, ITU-T H.1264 and Moving Picture Expert Group (MPEG)-4 Visual (also known as Advanced Video Coding (AVC)), ITU-T H.1265 and MPEG-H Part 2 (also known as High Efficiency Video Coding (HEVC), ITU-T H.1265 and MPEG-I Part 3 (also known as Versatile Video Coding (VVC)), the WebM VP8 and VP9 codecs, and AOMedia Video 1 (AV1). Encoder 114 may encode geometry of mesh sequence 108 based on video dynamic mesh coding (V-DMC). V-DMC specifies the encoded bitstream syntax and semantics for transmission or storage of a mesh sequence and the decoder operation for reconstructing the mesh sequence from the bitstream.

Output interface 116 may be configured to write and/or store bitstream 110 onto transmission medium 104 for transmission to destination device 106. In addition or alternatively, output interface 116 may be configured to transmit, upload, and/or stream bitstream 110 to destination device 106 via transmission medium 104. Output interface 116 may comprise a wired and/or wireless transmitter configured to transmit, upload, and/or stream bitstream 110 according to one or more proprietary and/or standardized communication protocols, such as Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, and Wireless Application Protocol (WAP) standards.

Transmission medium 104 may comprise a wireless, wired, and/or computer readable medium. For example, transmission medium 104 may comprise one or more wires, cables, air interfaces, optical discs, flash memory, and/or magnetic memory. In addition or alternatively, transmission medium 104 may comprise one more networks (e.g., the Internet) or file servers configured to store and/or transmit encoded video data.

To decode bitstream 110 into mesh sequence 108 for display or other forms of consumption, destination device 106 may comprise an input interface 118, a decoder 120, and a mesh display 122. Input interface 118 may be configured to read bitstream 110 stored on transmission medium 104 by source device 102. In addition or alternatively, input interface 118 may be configured to receive, download, and/or stream bitstream 110 from source device 102 via transmission medium 104. Input interface 118 may comprise a wired and/or wireless receiver configured to receive, download, and/or stream bitstream 110 according to one or more proprietary and/or standardized communication protocols, such as those mentioned above.

Decoder 120 may decode mesh sequence 108 from encoded bitstream 110. To decode attribute information (e.g., textures) of mesh sequence 108, decoder 120 may reconstruct the 2D images compressed using one or more 2D video encoders. Decoder 120 may then reconstruct the attribute information of 3D mesh frames 124 from the reconstructed 2D images. In some examples, decoder 120 may decode a mesh sequence that approximates mesh sequence 108 due to, for example, lossy compression of mesh sequence 108 by encoder 114 and/or errors introduced into encoded bitstream 110 during transmission to destination device 106. Further, decoder 120 may decode geometry of mesh sequence 108 from encoded bitstream 110, as will be further described below. Then, one or more of decoded attribute information may be applied to decoded mesh frames of mesh sequence 108.

Mesh display 122 may display mesh sequence 108 to a user. Mesh display 122 may comprise a cathode rate tube (CRT) display, a liquid crystal display (LCD), a plasma display, a light emitting diode (LED) display, a 3D display, a holographic display, a head mounted display, or any other display device suitable for displaying mesh sequence 108.

It should be noted that mesh coding/decoding system 100 is presented by way of example and not limitation. In the example of FIG. 1, mesh coding/decoding system 100 may have other components and/or arrangements. For example, mesh source 112 may be external to source device 102. Similarly, mesh display 122 may be external to destination device 106 or omitted altogether where mesh sequence is intended for consumption by a machine and/or storage device. In another example, source device 102 may further comprise a mesh decoder and destination device 106 may comprise a mesh encoder. In such an example, source device 102 may be configured to further receive an encoded bit stream from destination device 106 to support two-way mesh transmission between the devices.

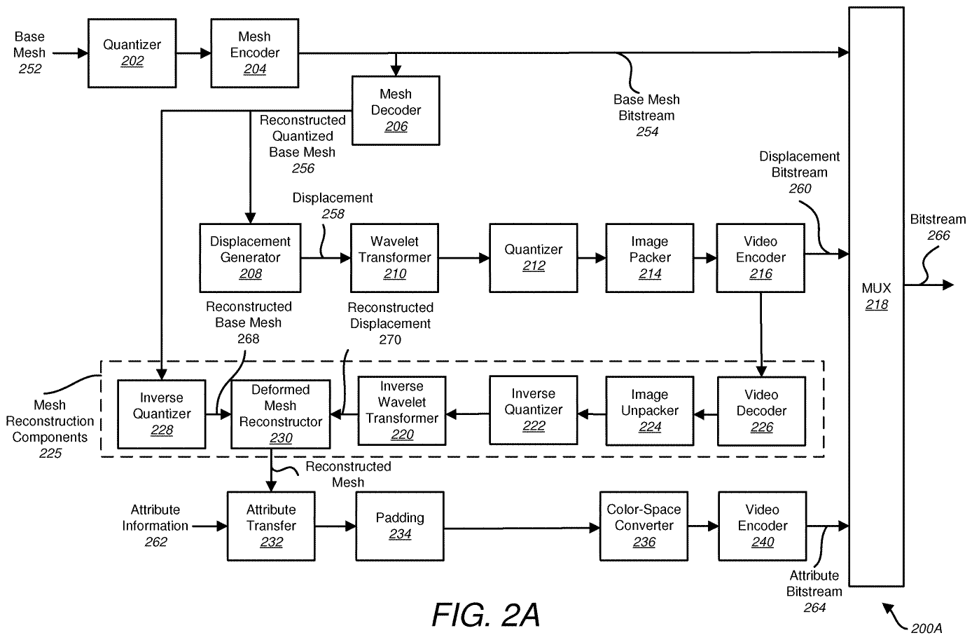

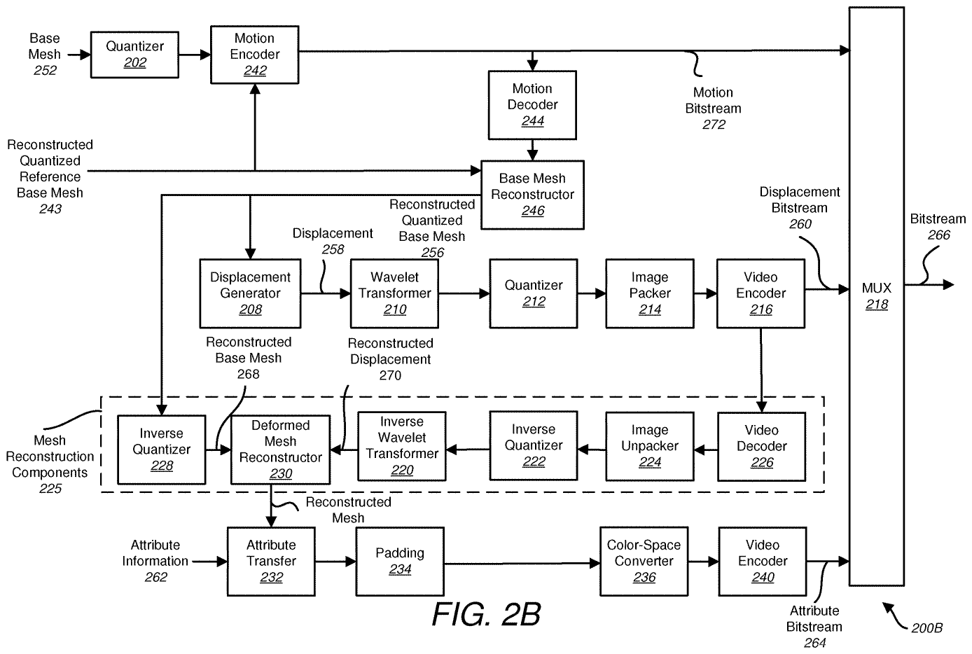

FIG. 2A illustrates a block diagram of an example encoder 200A for intra encoding a 3D mesh, according to some embodiments. For example, an encoder (e.g., encoder 114) may comprise encoder 200A.

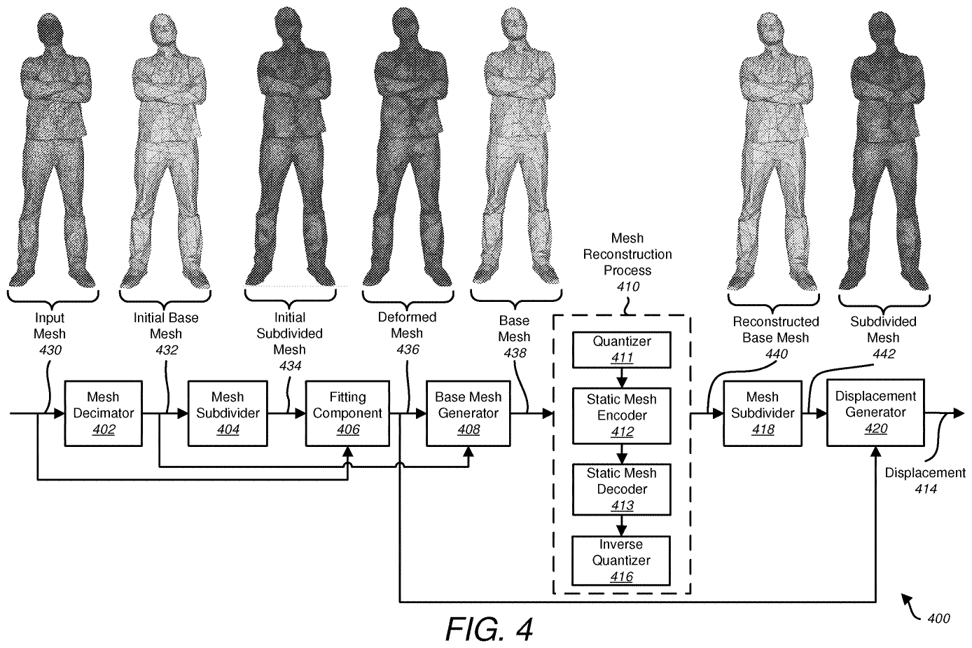

In some examples, a mesh sequence (e.g., mesh sequence 108) may include a set of mesh frames (e.g., mesh frames 124) that may be individually encoded and decoded. As will be further described below with respect to FIG. 4, a base mesh 252 may be determined (e.g., generated) from a mesh frame (e.g., an input mesh) through a decimation process. In the decimation process, the mesh topology of the mesh frame may be reduced to determine to the base mesh (e.g., a decimated mesh or decimated base mesh). A mesh encoder 204 may encode base mesh 252, whose geometry information (e.g., vertices) may quantized by quantizer 202, to generate a base mesh bitstream 254. In some examples, base mesh encoder 204 may be an existing encoder such as Draco or Edgebreaker.

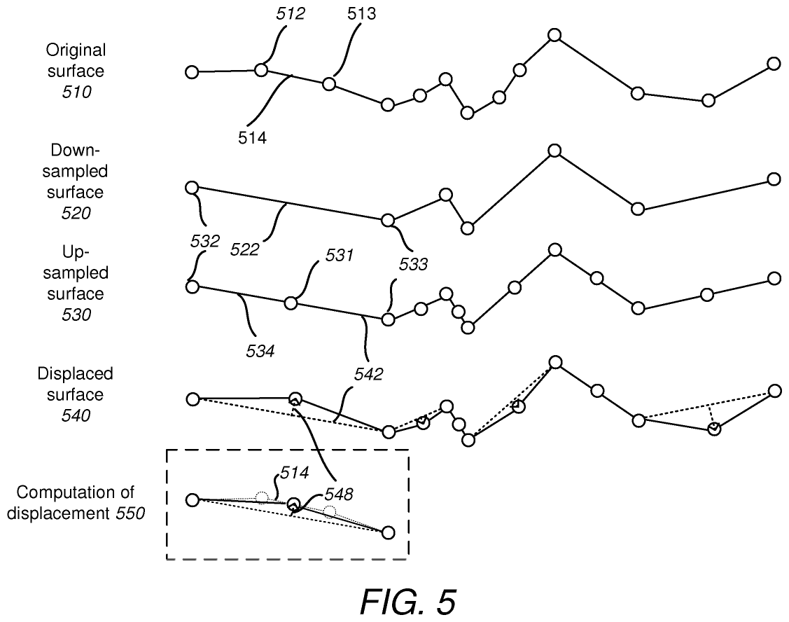

Displacement generator 208 may generate displacements for vertices of the mesh frame based on base mesh 252, as will be further explained below with respect to FIGS. 4 and 5. In some examples, the displacements are determined based on a reconstructed base mesh 256. Reconstructed base mesh 256 may be determined (e.g., output or generated) by mesh decoder 206 that decodes the encoded base mesh (e.g., in base mesh bitstream 254) determined (e.g., output or generated) by mesh encoder 204. Displacement generator 208 may subdivide reconstructed base mesh 256 using a subdivision scheme (e.g., subdivision algorithm) to determine a subdivided mesh (e.g., a subdivided base mesh). Displacement 258 may be determined based on fitting the subdivided mesh to an original input mesh surface. For example, displacement 258 for a vertex in the mesh frame may include displacement information (e.g., a displacement vector) that indicates a displacement from the position of the corresponding vertex in the subdivided mesh to the position of the vertex in the mesh frame.

Displacement 258 may be transformed by wavelet transformer 210 to generate wavelet coefficients (e.g., transformation coefficients) representing the displacement information and that may be more efficiently encoded (and subsequently decoded). The wavelet coefficients may be quantized by quantizer 212 and packed (e.g., arranged) by image packer 214 into a picture (e.g., one or more images or picture frames) to be encoded by video encoder 216. Mux 218 may combine (e.g., multiplex) the displacement bitstream 260 output by video encoder 216 together with base mesh bitstream 254 to form bitstream 266.

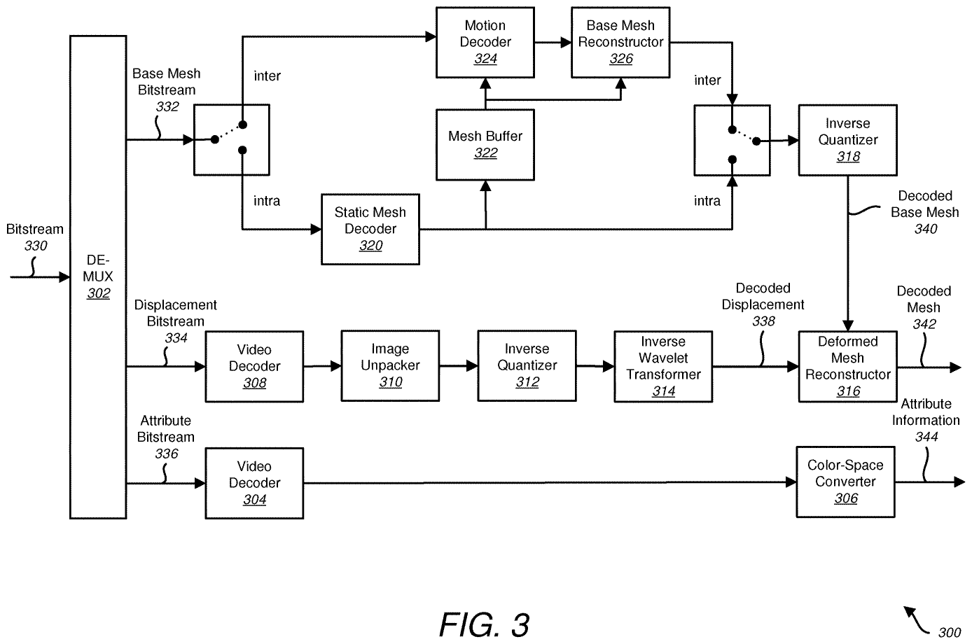

Attribute information 262 (e.g., color, texture, etc.) of the mesh frame may be encoded separately from the geometry information of the mesh frame described above. In some examples, attribute information 262 of the mesh frame may be represented (e.g., stored) by an attribute map (e.g., texture map) that associates each vertex of the mesh frame with corresponding attributes information of that vertex. Attribute transfer 232 may re-parameterize attribute information 262 in the attribute map based on reconstructed mesh determined (e.g., generated or output) from mesh reconstruction components 225. Mesh reconstruction components 225 perform inverse or decoding functions and may be the same or similar components in a decoder (e.g., decoder 300 of FIG. 3). For example, inverse quantizer 228 may inverse quantize reconstructed base mesh 256 to determine (e.g., generate or output) reconstructed base mesh 268. Video decoder 226, image unpacker 224, inverse quantizer 222, and inverse wavelet transformer 220 may perform the inverse functions as that of video encoder 216, image packer 214, quantizer 212, and wavelet transformer 210, respectively. Accordingly, reconstructed displacement 270, corresponding to displacement 258, may be generated from applying video decoder 226, image unpacker 224, inverse quantizer 222, and inverse wavelet transformer 220 in that order. Deformed mesh reconstructor 230 may determine the reconstructed mesh, corresponding to the input mesh frame, based on reconstructed base mesh 268 and reconstructed displacement 270. In some examples, the reconstructed mesh may be the same decoded mesh determined from the decoder based on decoding base mesh bitstream 254 and displacement bitstream 260.

Attribute information of the re-parameterized attribute map may be packed in images (e.g., 2D images or picture frames) by padding component 234. Padding component 234 may fill (e.g., pad) portions of the images that do not contain attribute information. In some examples, color-space converter 236 may translate (e.g., convert) the representation of color (e.g., an example of attribute information 262) from a first format to a second format (e.g., from RGB444 to YUV420) to achieve improved rate-distortion (RD) performance when encoding the attribute maps. In an example, color-space converter 236 may also perform chroma subsampling to further increase encoding performance. Finally, video encoder 240 encodes the images (e.g., pictures frames) representing attribute information 262 of the mesh frame to determine (e.g., generate or output) attribute bitstream 264 multiplexed by mux 218 into bitstream 266. In some examples, video encoder 240 may be an existing 2D video compression encoder such as an HEVC encoder or a VVC encoder.

FIG. 2B illustrates a block diagram of an example encoder 200B for inter encoding a 3D mesh, according to some embodiments. For example, an encoder (e.g., encoder 114) may comprise encoder 200B. As shown in FIG. 2B, encoder 200B comprises many of the same components as encoder 200A. In contrast to encoder 200A, encoder 200B does not include mesh encoder 204 and mesh decoder 206, which correspond to coders for static 3D meshes. Instead, encoder 200B comprises a motion encoder 242, a motion decoder 244, and a base mesh reconstructor 246. Motion encoder 242 may determine a motion field (e.g., one or more motion vectors (MVs)) that, when applied to a reconstructed quantized reference base mesh 243, best approximates base mesh 252.

The determined motion field may be encoded in bitstream 266 as motion bitstream 272. In some examples, the motion field (e.g., a motion vector in the x, y, and z directions) may be entropy coded as a codeword (e.g., for each directional component) resulting from a coding scheme such as a unary, a Golomb code (e.g., Exp-Golomb code), a Rice code, or a combination thereof. In some examples, the codeword may be arithmetically coded, e.g., using CABAC. A prefix part of the codeword may be context coded and a suffix part of the coded may be bypass codded. In some examples, a sign bit for each directional component of the motion vector may be coded separately.

In some examples, motion bitstream 272 may further include indication of the selected reconstructed quantized reference base mesh 243.

In some examples, motion bitstream 272 may be decoded by motion decoder 244 and used by base mesh reconstructor 246 to generate reconstructed quantized base mesh 256. For example, base mesh reconstructor 246 may apply the decoded motion field to reconstructed quantized reference base mesh 243 to determine (e.g., generate) reconstructed quantized base mesh 256.

In some examples, a reconstructed quantized reference base mesh m′(j) associated with a reference mesh frame with index j may be used to predict the base mesh m(i) associated with the current frame with index i. Base meshes m(i) and m(j) may comprise the same: number of vertices, connectivity, texture coordinates, and texture connectivity. The positions of vertices may differ between base meshes m(i) and m(j).

In some examples, the motion field f(i) may be computed by considering the quantized version of m(i) and the reconstructed quantized base mesh m′(j). Base mesh m′(j) may have a different number of vertices than m(j) (e.g., vertices may have been merged or removed). Therefore, the encoder may track the transformation applied to m(j) to determine (e.g., generate or obtain) m′( ) and apply it to m(i). This transformation may enable a 1-to-1 correspondence between vertices of base mesh m′(j) and the transformed and quantized version of base mesh m(i), denoted as m\hat{ }*(i). The motion field f(i) may be computed by subtracting the quantized positions p(i,v) of the vertex v of m\hat{ }*(i) from the positions Pos(j,v) of the vertex v of m′(j) as follows: f(i,v)=Pos(i,v)−Pos(j,v). The motion field may be further predicted by using the connectivity information of base mesh m′(j) and the prediction residuals may be entropy encoded.

In some examples, since the motion field compression process may be lossy, a reconstructed motion field denoted as f′(i) may be computed by applying the motion decoder component. A reconstructed quantized base mesh m′(i) may then be computed by adding the motion field to the positions of vertices in base mesh m′(j). To better exploit temporal correlation in the displacement and attribute map images (e.g., sequence/video of images), inter prediction may be enabled in the video encoder.

In some embodiments, an encoder (e.g., encoder 114) may comprise encoder 200A and encoder 200B.

FIG. 3 illustrates a diagram showing an example decoder 300. Bitstream 330, which may correspond to bitstream 266 in FIGS. 2A and 2B and may be received in a binary file, may be demultiplexed by de-mux 302 to separate bitstream 330 into base mesh bitstream 332, displacement bitstream 334, and attribute bitstream 336 carrying base mesh geometry information, displacement geometry information, and attribute information, respectively. Attribute bitstream 336 may include one or more attribute map sub-streams for each attribute type.

In some examples, for inter decoding, the bitstream is de-multiplexed into separate sub-streams, including: a motion sub-stream, a displacement sub-stream for positions and potentially for each vertex attribute, zero or more attribute map sub-streams, and an atlas sub-stream containing patch information in the same manner as in V3CV-PCC.

In some examples, base mesh bitstream 332 may be decoded in an intra mode or an inter mode. In the intra mode, static mesh decoder 320 may decode base mesh bitstream 332 (e.g., to generate reconstructed base mesh m′(i)) that is then inverse quantized by inverse quantizer 318 to determine (e.g., generate or output) decoded base mesh 340 (e.g., reconstructed quantized base mesh m″(i)). In some examples, static mesh decoder 320 may correspond to mesh decoder 206 of FIG. 2A.

In some examples, in the inter mode, base mesh bitstream 332 may include motion field information that is decoded by motion decoder 324. In some examples, motion decoder 324 may correspond to motion decoder 244 of FIG. 2B. For example, motion decoder 324 may entropy decode base mesh bitstream 332 to determine motion field information. In the inter mode, base mesh bitstream 332 may indicate a previous base mesh (e.g., reference base mesh m′(j)) decoded by static mesh decoder 320 and stored (e.g., buffered) in mesh buffer 322. Base mesh reconstructor 326 may generate a quantized reconstructed base mesh m′(i) by applying the decoded motion field (output by motion decoder 324) to the previously decoded (e.g., reconstructed) base mesh m′(j) stored in mesh buffer 322. In some examples, base mesh reconstructor 326 may correspond to base mesh reconstructor 246 of FIG. 2B. The quantized reconstructed base mesh may be inverse quantized by inverse quantizer 318 to determine (e.g., generate or output) decoded base mesh 340 (e.g., reconstructed base mesh m″(i)). In some examples, decoded base mesh 340 may be the same as reconstructed base mesh 268 in FIGS. 2A and 2B.

In some examples, decoder 300 includes video decoder 308, image unpacker 310, inverse quantizer, and inverse wavelet transformer 314 that determines (e.g., generates) decoded displacement 338 from displacement bitstream 334. Video decoder 308, image unpacker 310, inverse quantizer, and inverse wavelet transformer 314 correspond to video decoder 226, image unpacker 224, inverse quantizer 222, and inverse wavelet transformer 220, respectively, and perform the same or similar operations. For example, the picture frames (e.g., images) received in displacement bitstream 334 may be decoded by video decoder 308, the displacement information may be unpacked by image unpacker 310 from the decoded image, inverse quantized by inverse quantizer 312 to determined inverse quantized wavelet coefficients representing encoded displacement information. Then, the unquantized wavelet coefficients may be inverse transformed by inverse wavelet transformer 314 to determine decoded displacement d″(i). In other words decoded displacement 338 (e.g., decoded displacement field d″(i)) may be the same as reconstructed displacement 270 in FIGS. 2A and 2B.

Deformed mesh reconstructor 316, which corresponds to deformed mesh reconstructor 230, may determine (e.g., generate or output) decoded mesh 342 (M″(i)) based on decoded displacement 338 and decoded base mesh 340. For example, deformed mesh reconstructor 316 may combine (e.g., add) decoded displacement 338 to a subdivided decoded mesh 340 to determine decoded mesh 342.

In some examples, decoder 300 includes video decoder 304 that decodes attribute bitstream 336 comprising encoded attribute information represented (e.g., stored) in 2D images (or picture frames) to determined attribute information 344 (e.g., decoded attribute information or reconstructed attribute information). In some examples, video decoder 304 may be an existing 2D video compression decoder such as an HEVC decoder or a VVC decoder. Decoder 300 may include a color-space converter 306, which may revert the color format transformation performed by color-space converter 236 in FIGS. 2A and 2B.

FIG. 4 is a diagram 400 showing an example process (e.g., a pre-processing operations) for generating displacements 414 of an input mesh 430 (e.g., an input 3D mesh frame) to be encoded, according to some embodiments. In some examples, displacements 414 may correspond to displacement 258 shown in FIG. 2A and FIG. 2B.

In diagram 400, a mesh decimator 402 determines (e.g., generates or outputs) an initial base mesh 432 based on (e.g., using) input mesh 430. In some examples, the initial base mesh 432 may be determined (e.g., generated) from the input mesh 432 through a decimation process. In the decimation process, the mesh topology of the mesh frame may be reduced to determine the initial base mesh (which may be referred to as a decimated mesh or decimated base mesh). As will be illustrated in FIG. 5, the decimation process may involve a down sampling process to remove vertices from the input mesh 432 so that a small portion (e.g., 6% or less) of the vertices in the input mesh 430 may remain in the initial base mesh 432.

Mesh subdivider 404 applies a subdivision scheme to generate initial subdivided mesh 434. As will be discussed in more detail with regard to FIG. 5, the subdivision scheme may involve upsampling the initial base mesh 432 to add more vertices to the 3D mesh based on the topology and shape of the original mesh to generate the initial subdivided mesh 434.

Fitting component 406 may fit the initial subdivided mesh to determine a deformed mesh 436 that may more closely approximate the surface of input mesh 430. As will be discussed in more detail with respect to FIG. 5, the fitting may be performed by moving vertices of the initial subdivided mesh 434 towards the surfaces of the input mesh 430 so that the subdivided mesh 434 can be used to approximate the input mesh 430. In some implementations, the fitting is performed by moving each vertex of the initial subdivided mesh 434 along the normal direction of the vertex until the vertex intersects with a surface of the input mesh 430. The resulting mesh is the deformed mesh 436. The normal direction may be indicated by a vertex normal at the vertex, which may be obtained from face normals of triangles formed by the vertex.

Base mesh generator 408 may perform another fitting process to generate a base mesh 438 from the initial base mesh 432. For example, the base mesh generator 408 may deform the initial base mesh 432 according to the deformed mesh 436 so that the initial base mesh 432 is close to the deformed mesh 436. In some implementations, the fitting process may be performed in a similar manner to the fitting component 406. For example, the base mesh generator 408 may move each of the vertices in the initial base mesh 432 along its normal direction (e.g., based on the vertex normal at each vertex) until the vertex reaches a surface of the deformed mesh 436. The output of this process is the base mesh 438.

Base mesh 438 may be output to a mesh reconstruction process 410 to generate a reconstructed base mesh 440. Reconstructed base mesh 440 may be subdivided by mesh subdivider 418 and the subdivided mesh 442 may be input to displacement generator 420 to generate (e.g., determine or output) displacement 414, as further described below with respect to FIG. 5. In some examples, mesh subdivider 418 may apply the same subdivision scheme as that applied by mesh subdivider 404. In these examples, vertices in the subdivided mesh 442 have a one-to-one correspondence with the vertices in the deformed mesh 436. As such, the displacement generator 420 may generate the displacements 414 by calculating the difference between each vertex of the subdivided mesh 442 and the corresponding vertex of the deformed mesh 436. In some implementations, the difference may be projected onto a normal direction of the associated vertex and the resulting vector is the displacement 414. In this way, only the sign and magnitude of the displacement 414 need to be encoded in the bitstream, thereby increasing the coding efficiency. In addition, because the base mesh 438 has been fitted toward the deformed mesh 436, the displacements 414 between the deformed mesh 436 and the subdivided mesh 442 (generated from the reconstructed base mesh 440) will have small magnitudes, which further reduces the payload and increases the coding efficiency.

In some examples, one advantage of applying the subdivision process is to allow for more efficient compression, while offering a faithful approximation of the original input mesh 430 (e.g., surface or curve of the original input mesh 430). The compression efficiency may be obtained because the base mesh (e.g., decimated mesh) has a lower number of vertices compared to the number of vertices of input mesh 430 and thus requires a fewer number of bits to be encoded and transmitted. Additionally, the subdivided mesh may be automatically generated by the decoder once the base mesh has been decoded without any information needed from the encoder other than a subdivision scheme (e.g., subdivision algorithm) and parameters for the subdivision (e.g., a subdivision iteration count). The reconstructed mesh may be determined by decoding displacement information (e.g., displacement vectors) associated with vertices of the subdivided mesh (e.g., subdivided curves/surfaces of the base mesh). Not only does the subdivision process allow for spatial/quality scalability, but also the displacements may be efficiently coded using wavelet transforms (e.g., wavelet decomposition), which further increases compression performance.

In some embodiments, mesh reconstruction process 410 includes components for encoding and then decoding base mesh 438. FIG. 4 shows an example for the intra mode, in which mesh reconstruction process 410 may include quantizer 411, static mesh encoder 412, static mesh decoder 413, and inverse quantizer 416, which may perform the same or similar operations as quantizer 202, mesh encoder 204, mesh decoder 206, and inverse quantizer 228, respectively, from FIG. 2A. For the inter mode, mesh reconstruction process 410 may include quantizer 202, motion encoder 242, motion decoder 244, base mesh reconstructor 246, and inverse quantizer 228.

FIG. 5 illustrates an example process for approximating and encoding a geometry of a 3D mesh, according to some embodiments. For illustrative purposes, the 3D mesh is shown as 2D curves. An original surface 510 of the 3D mesh (e.g., a mesh frame) includes vertices (e.g., points) and edges that connect neighboring vertices. For example, point 512 and point 513 are connected by an edge corresponding to surface 514.

In some examples, a decimation process (e.g., a down-sampling process or a decimation/down-sampling scheme) may be applied to an original surface 510 of the original mesh to generate a down-sampled surface 520 of a decimated (or down-sampled) mesh. In the context of mesh compression, decimation refers to the process of reducing the number of vertices in a mesh while preserving its overall shape and topology. For example, original mesh surface 510 is decimated into a surface 520 with fewer samples (e.g., vertices and edges) but still retains the main features and shape of the original mesh surface 510. This down-sample surface 520 may correspond to a surface of the base mesh (e.g., a decimated mesh).

In some examples, after the decimation process, a subdivision process (e.g., subdivision scheme or subdivision algorithm) may be applied to down-sampled surface 520 to generate an up-sampled surface 530 with more samples (e.g., vertices and edges). Up-sampled surface 530 may be part of the subdivided mesh (e.g., subdivided base mesh) resulting from subdividing down-sampled surface 520 corresponding to a base mesh.

Subdivision is a process that is commonly used after decimation in mesh compression to improve the visual quality of the compressed mesh. The subdivision process involves adding new vertices and faces to the mesh based on the topology and shape of the original mesh. In some examples, the subdivision process starts by taking the reduced mesh that was generated by the decimation process and iteratively adding new vertices and edges. For example, the subdivision process may comprise dividing each edge (or face) of the reduced/decimated mesh into shorter edges (or smaller faces) and creating new vertices at the points of division. These new vertices are then connected to form new faces (e.g., triangles, quadrilaterals, or another polygon). By applying subdivision after the decimation process, a higher level of compression can be achieved without significant loss of visual fidelity. Various subdivision schemes may be used such as, e.g., mid-point, Catmull-Clark subdivision, Butterfly subdivision, Loop subdivision, etc., or a combination thereof.

For example, FIG. 5 illustrates an example of the mid-point subdivision scheme. In this scheme, each subdivision iteration subdivides each triangle into four sub-triangles. New vertices are introduced in the middle of each edge. The subdivision process may be applied independently to the geometry and to the texture coordinates since the connectivity for the geometry and for the texture coordinates are usually different. The subdivision scheme computes the position Pos(v₁₂) of a newly introduced vertex v₁₂ at the center of an edge (v₁, v₂) formed by a first vertex (v₁) and a second vertex (v₂), as follows:

$$P o s ( {v}_{12} ) = \frac{1}{2} ( P o s ( {v}_{1} ) + P o s ( {v}_{2} ) ) ,$$

where Pos(v₁) and Pos(v₂) are the positions of the vertices v₁ and v₂. In some examples, the same process may be used to compute the texture coordinates of the newly created vertex. For normal vectors, a normalization step may be applied as follows:

$$N ( {v}_{12} ) = \frac{N ( {v}_{1} ) + N ( {v}_{2} )}{‖ N ( {v}_{1} ) + N ( {v}_{2} ) ‖} ,$$

where N(v₁₂), N(v₁), and N(v₂) are the normal vectors associated with the vertices v₁₂, v₁, and v₂, respectively. ∥x∥ is the norm2 of the vector x.

Using the mid-point subdivision scheme, as shown in up-sampled surface 530, point 531 may be generated as the mid-point of edge 522 which is an edge connecting point 532 and point 533. Point 531 may be added as a new vertex. Edge 534 and edge 542 are also added to connect the added new vertex corresponding to point 531. In some examples, the original edge 522 may be replaced by two new edges 534 and 542.

In some examples, down-sampled surface 520 may be iteratively subdivided to generate up-sampled surface 530. For example, a first subdivided mesh resulting from a first iteration of subdivision applied to down-sampled surface 520 may be further subdivided according to the subdivision scheme to generate a second subdivided mesh, etc. In some examples, a number of iterations corresponding to levels of subdivision may be predetermined. In other examples, an encoder may indicate the number of iterations to a decoder, which may similarly generate a subdivided mesh, as further described above.

In some embodiments, the subdivided mesh may be deformed towards (e.g., approximates) the original mesh to determine (e.g., get or obtain) a prediction of the original mesh having original surface 510. The points on the subdivided mesh may be moved along a computed normal vertex/orientation until it reaches an original surface 510 of the original mesh. The distance between the intersected point on the original surface 510 and the subdivided point may be computed as a displacement (e.g., a displacement vector). For example, point 531 may be moved towards the original surface 510 along a computed normal orientation of surface (e.g., represented by edge 542). When point 531 intersects with surface 514 of the original surface 510 (of original/input mesh), a displacement vector 548 can be computed. Displacement vector 548 applied to point 531 may result in displaced surface 540, which may better approximate original surface 510. In some examples, displacement information (e.g., displacement vector 548) for vertices of the subdivided mesh (e.g., up-sampled surface 530 of subdivided mesh) may be encoded and transmitted in displacement bitstream 260 shown in examples encoders of FIGS. 2A and 2B. Note, as explained with respect to FIG. 4, the subdivided mesh corresponding to up-sampled surface may be subdivided mesh 442 that is compared to deformed mesh 436 representative of original surface 510 of the input mesh.

In some embodiments, displacements d(i) (e.g., a displacement field or displacement vectors) may be computed and/or stored based on local coordinates or global coordinates. For example, a global coordinate system is a system of reference that is used to define the position and orientation of objects or points in a 3D space. It provides a fixed frame of reference that is independent of the objects or points being described. The origin of the global coordinate system may be defined as the point where the three axes intersect. Any point in 3D space can be located by specifying its position relative to the origin along the three axes using Cartesian coordinates (x, y, z). For example, the displacements may be defined in the same cartesian coordinate system as the input or original mesh.

In a local coordinate system, a normal, a tangent, and/or a binormal vector (which are mutually perpendicular) may be determined that defines a local basis for the 3D space to represent the orientation and position of an object in space relative to a reference frame. In some examples, displacement field d(i) may be transformed from the canonical coordinate system to the local coordinate system, e.g., defined by a normal to the subdivided mesh at each vertex (e.g., commonly referred to as a vertex normal). The normal at each vertex may be obtained from combining the face normals of triangles formed by the vertex. In some examples, using the local coordinate system may enable further compression of tangential components of the displacements compared to the normal component.

In some embodiments, a decoder (e.g., decoder 300 of FIG. 3) may receive and decode a base mesh corresponding to (e.g., having) down-sampled surface 520. Similar to the encoder, the decoder may apply a subdivision scheme to determine a subdivided mesh having up-sampled surface 530 generated from down-sampled surface 520. The decoder may receive and decode displacement information including displacement vector 548 and determine a decoded mesh (e.g., reconstructed mesh) based on the subdivided mesh (corresponding to up-sampled surface 530) and the decoded displacement information. For example, the decoder may add the displacement at each vertex with a position of the corresponding vertex in the subdivided mesh. The decoder may obtain a reconstructed 3D mesh by combining the obtained/decoded displacements with positions of vertices of the subdivided mesh.

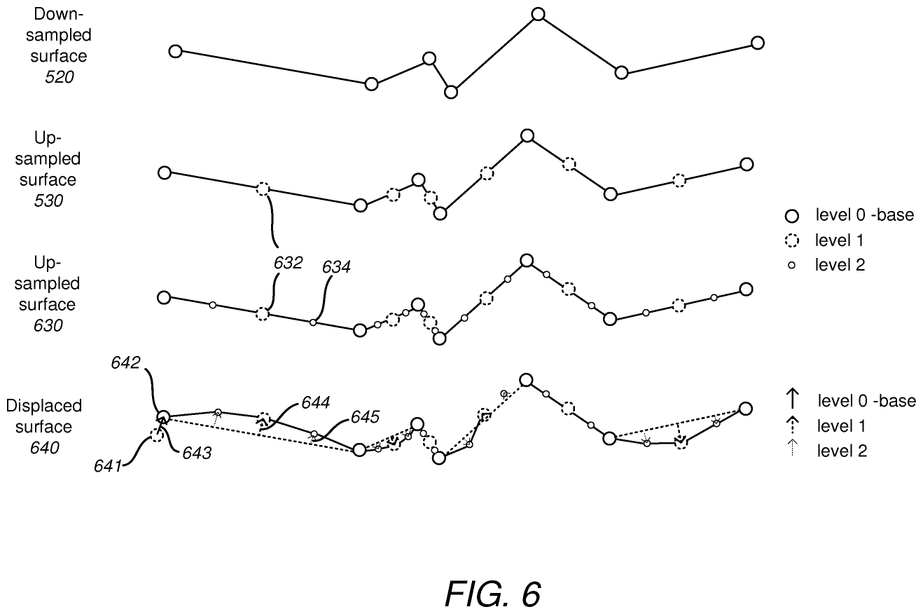

FIG. 6 illustrates an example of vertices of a subdivided mesh (e.g., a subdivided base mesh) corresponding to multiple levels of detail (LODs), according to some embodiments. As described above with respect to FIG. 5, the subdivision process (e.g., subdivision scheme) may be an iterative process, in which a mesh can be subdivided multiple times and a hierarchical data structure is generated containing multiple levels. Each level of the hierarchical data structure may include different numbers of data samples (e.g., vertices and edges in mesh) representing (e.g., forming) different density/resolution (e.g., also referred to as levels of details (LoDs)). For example, a down-sampled surface 520 (of a decimated mesh) can be subdivided into up-sampled surface 530 after a first iteration of subdivision. Up-sampled surface 530 may be further subdivided into up-sampled surface 630 and so forth. In this case, vertices of the mesh with down-sampled surface 520 may be considered as being in or associated with LOD0. Vertices, such as vertex 632, generated in up-sampled surface 530 after a first iteration of subdivision may be at LOD1. Vertices, such as vertex 634, generated in up-sampled surface 630 after another iteration of subdivision may be at LOD2, etc. In some examples, an LOD0 may refer to the vertices resulting from decimation of an input (e.g., original) mesh resulting in a base mesh with (e.g., having) down-sampled surface 520. For example, vertices at LOD0 may be vertices of a reconstructed quantized base mesh 256 of FIGS. 2A-B, reconstructed/decoded base mesh 340 of FIG. 3, reconstructed base mesh 440 of FIG. 4.

In some examples, the computation of displacements in different LODs follows the same mechanism as described above with respect to FIG. 5. In some examples, a displacement vector 643 may be computed from a position of a vertex 641 in the original surface 510 (of original mesh) to a vertex 642, from displace surface 640 of the deformed mesh, at LOD0. The displacement vectors 644 and 645 of corresponding vertices 632 and 634 from LOD1 and LOD 2, respectively, may be similarly calculated. Accordingly, in some examples, a number of iterations of subdivision may correspond to a number of LODs and one of the iterations may correspond to one LOD of the LODs.

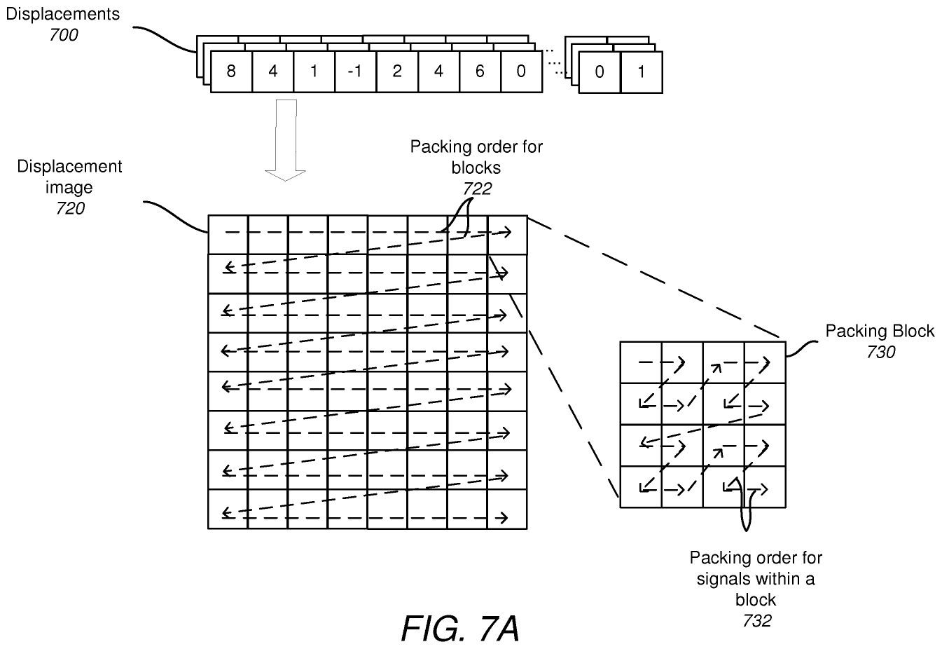

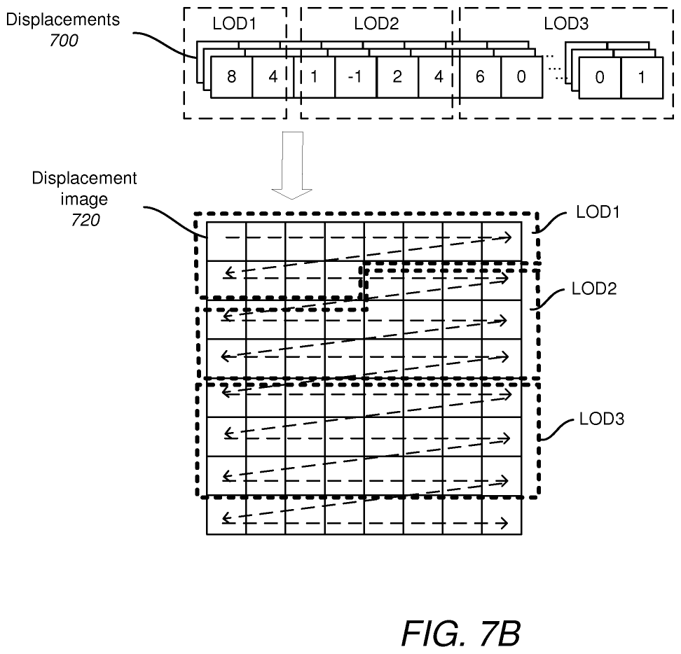

FIG. 7A illustrates an example of an image 720 (e.g., picture or a picture frame) packed with displacements 700 (e.g., displacement fields or vectors) using a packing method (e.g., a packing scheme or a packing algorithm), according to some embodiments. Specifically, displacements 700 may be generated, as described above with respect to FIG. 5 and FIG. 6, and packed into 2D images. In some examples, a displacement can be a 3D vector containing the values for the three components of the distance. For example, a delta x value represents the shift on the x-axis from a point A to a point B in a Cartesian coordinate system. In some examples, a displacement vector may be represented by less than three components, e.g., by one or two components. For example, when a local coordinate system is used to store the displacement value, one component with the highest significance may be stored as being representative of the displacement and the other components may be discarded.

In some examples, as will be further described below, a displacement value may be transformed into other signal domains for achieving better compression. For example, a displacement can be wavelet transformed and be decomposed into and represented as wavelet coefficients (e.g., coefficient values or transform coefficients). In these examples, displacements 700 that are packed in image 720 may comprise the resulting wavelet coefficients (e.g., transform coefficients), which may be more efficiently compressed than the un-transformed displacement values. At the decoder side, a decoder may decode displacements 700 as wavelet coefficients and may apply an inverse wavelet transform process to reconstruct the original displacement values obtained at the encoder.

In some examples, one or more of displacements 700 may be quantized by the encoder before being packed into displacement image 720. In some examples, one or more displacements may be quantized before being wavelet transformed, after being wavelet transformed, or quantized before and after being wavelet transformed. For example, FIG. 7A shows quantized wavelet transform values 8, 4, 1, −1, etc. in displacements 700. At the decoder side, the decoder may perform inverse quantization to reverse or undo the quantization process performed by the encoder.

In general, quantization in signal processing may be the process of mapping input values from a larger set to output values in a smaller set. It is often used in data compression to reduce the amount, the precision, or the resolution of the data into a more compact representation. However, this reduction can lead to a loss of information and introduce compression artifacts. The choice of quantization parameters, such as the number of quantization levels, is a trade-off between the desired level of precision and the resulting data size. There are many different quantization techniques, such as uniform quantization, non-uniform quantization, and adaptive quantization that may be selected/enabled/applied. They can be employed depending on the specific requirements of the application.

In some examples, wavelet coefficients (e.g., displacement coefficients representing displacement signals) may be adaptively quantized according to LODs. As explained above, a mesh may be iteratively subdivided to generate a hierarchical data structure comprising multiple LODs. In this example, each vertex and its associated displacement belong to the same level of hierarchy in the LOD structure, e.g., an LOD corresponding to a subdivision iteration in which that vertex was generated. In some examples, a vertex at each LOD may be quantized according to quantization parameters, corresponding to LODs, that specify different levels of intensity/precision of the signal to be quantized. For example, wavelet coefficients in LOD 3 may have a quantization parameter of, e.g., 42 and wavelet coefficients in LOD 0 may have a different, smaller quantization parameter of 28 to preserve more detail information in LOD 0.

In some examples, displacements 700 may be packed onto the pixels in a displacement image 720 with a width W and a height H. In an example, a size of displacement image 720 (e.g., W multiplied by H) may be greater or equal to the number of components in displacements 700 to ensure all displacement information may be packed. In some examples, displacement image 720 may be further partitioned into smaller regions (e.g., squares) referred to as a packing block 730. In an example, the length of packing block 730 may be an integer multiple of 2.

Displacements 700 (e.g., displacement signals represented by quantized wavelet coefficients) may be packed into a packing block 730 according to a packing order 732. Each packing block 730 may be packed (e.g., arranged or stored) in displacement image 720 according to a packing order 722. Once all the displacements 700 are packed, the empty pixels in image 720 may be padded with neighboring pixel values for improved compression. In the example shown in FIG. 7A, packing order 722 for packing blocks may be a raster order and a packing order 732 for displacements within packing block 730 may be, for example, a Z-order. However, it should be understood that other packing schemes both for blocks and displacements within blocks may be used. In some embodiments, a packing scheme for the blocks and/or within the blocks may be predetermined. In some embodiments, the packing scheme may be signaled by the encoder in the bitstream per patch, patch group, tile, image, or sequence of images. Relatedly, the signaled packing scheme may be obtained by the decoder from the bitstream.

In some examples, packing order 732 may follow a space-filling curve, which specifies a traversal in space in a continuous, non-repeating way. Some examples of space-filling curve algorithms (e.g., schemes) include Z-order curve, Hilbert Curve, Peano Curve, Moore Curve, Sierpinski Curve, Dragon Curve, etc. Space-filling curves have been used in image packing techniques to efficiently store and retrieve images in a way that maximizes storage space and minimizes retrieval time. Space-filling curves are well-suited to this task because they can provide a one-dimensional representation of a two-dimensional image. One common image packing technique that uses space-filling curves is called the Z-order or Morton order. The Z-order curve is constructed by interleaving the binary representations of the x and y coordinates of each pixel in an image. This creates a one-dimensional representation of the image that can be stored in a linear array. To use the Z-order curve for image packing, the image is first divided into small blocks, typically 8×8 or 16×16 pixels in size. Each block is then encoded using the Z-order curve and stored in a linear array. When the image needs to be retrieved, the blocks are decoded using the inverse Z-order curve and reassembled into the original image.

In some examples, once packed, displacement image 720 may be encoded and decoded using a conventional 2D video codec.

FIG. 7B illustrates an example of displacement image 720, according to some embodiments. As shown, displacements 700 packed in displacement image 720 may be ordered according to their LODs. For example, displacement coefficients (e.g., quantized wavelet coefficients) may be ordered from a lowest LOD to a highest LOD. In other words, a wavelet coefficient representing a displacement for a vertex at a first LOD may be packed (e.g., arranged and stored in displacement image 720) according to the first LOD. For example, displacements 700 may be packed from a lowest LOD to a highest LOD. Higher LODs represent a higher density of vertices and corresponds to more displacements compared to lower LODs. The portion of displacement image 720 not in any LOD may be a padded portion.

In some examples, displacements may be packed in inverse order from highest LOD to lowest LOD. In an example, the encoder may signal whether displacements are packed from lowest to highest LOD or from highest to lowest LOD.

In some examples, a wavelet transform may be applied to displacement values to generate wavelet coefficients (e.g., displacement coefficients) that may be more easily compressed. Wavelet transforms are commonly used in signal processing to decompose a signal into a set of wavelets, which are small wave-like functions allowing them to capture localized features in the signal. The result of the wavelet transform is a set of coefficients that represent the contribution of each wavelet at different scales and positions in the signal. It is useful for detecting and localizing transient features in a signal and is generally used for signal analysis and data compression such as image, video, and audio compression.

Taking a 2D image as an example, wavelet transform is used to decompose an image (signals) into two discrete components, known as approximations/predictions and details. The decomposed signals are further divided into a high frequency component (details) and a low frequency component (approximations/predictions) by passing through two filters, high and low pass filters. In the example of 2D image, two filtering stages, a horizontal and a vertical filtering are applied to the image signals. A down-sampling step is also required after each filtering stage on the decomposed components to obtain the wavelet coefficients resulting in four sub-signals in each decomposition level. The high frequency component corresponds to rapid changes or sharp transitions in the signal, such as an edge or a line in the image. On the other hand, the low frequency component refers to global characteristics of the signal. Depending on the application, different filtering and compression can be achieved. There are various types of wavelets such as Haar, Daubechies, Symlets, etc., each with different properties such as frequency resolution, time localization, etc.

In signal processing, a lifting scheme is a technique for both designing wavelets and performing the discrete wavelet transform (DWT). It is an alternative approach to the traditional filter bank implementation of the DWT that offers several advantages in terms of computational efficiency and flexibility. It decomposes the signal using a series of lifting steps such that the input signal, e.g., displacements for 3D meshes, may be converted to displacement coefficients in-place. In the lifting scheme, a series of lifting operations (e.g. lifting steps) may be performed. Each lifting operation involves a prediction step (e.g., prediction operation) and an update step (e.g., update operation). These lifting operations may be applied iteratively to obtain the wavelet coefficients.

In various implementations of 3D mesh coding, displacements for 3D mesh frames may be transformed using a wavelet transform with lifting, e.g., referred to as a lifting scheme. Specifically, the wavelet transform may “split” the input signal (e.g., a displacement signal) into two signals: the even-samples signal E and the odd-sample 0 signal. The even samples E may comprise two displacement signals E₁ and E₂ associated with two vertices that are considered to be on an edge of the vertex associated with the input displacement signal. The odd sample 0 may represent an input signal corresponding to that vertex. As explained above, the edge information may be determined (e.g., generated or received) from the subdivision scheme applied to each mesh frame of the 3D mesh. A prediction of the odd-sample 0 signal may be determined based on a weighted sum of the even-samples signal E. Then, the odd-sample 0 signal may be encoded as a difference between the odd-sample 0 signal. Further, each of the even-sample signals E₁ and E₂ may be adjusted based on the difference weighted by an updated weight, which may be associated with the odd-sample 0 signal (e.g., associated with an LOD of the odd-sample 0 signal).

In some embodiments, wavelet coefficients (e.g., transformed wavelet coefficients) representing displacements corresponding to vertices of 3D mesh geometry may be quantized according to a quantization parameter that is set for each LOD of a plurality of LODs. The vertices may be at (e.g., generated) across the plurality of LODs. Further, wavelet coefficients within each LOD may be quantized with a dead-zone quantizer. The dead-zone quantizer may be a type of quantizer with symmetric behavior around a quantized value of 0 and reaches its peak value at zero. The region around the 0 output value of such a quantizer is referred to as the dead zone. The dead zone may be configured with a different width than that for the other quantization steps of the quantizer. The dead-zone quantizer may be a uniform quantizer such that the other quantization steps besides the dead zone have uniform width (e.g., quantization size). In other words, with the dead-zone quantizer being set to a same size as the quantization step, each quantization step of the dead-zone quantizer is the same or uniform.

In some examples, wavelet coefficients of vertices at different LODs may be quantized (and inverse quantized) according to their corresponding LODs, which specify different levels of intensity (e.g., precision) or a signal to be scaled. For example, wavelet coefficients of vertices in LOD 3 may have a quantization scaling factor of, e.g., ⅛ and wavelet coefficients of vertices in LOD 0 may have a different, greater quantization scaling factor value of, e.g., 1 to preserve more detail information in LOD 0 (e.g., such that wavelet coefficients at higher LODs are quantized by a larger quantization step). Relatedly, the inverse scaling factors may be, e.g., 8 associated with LOD 3 and, e.g., 1 associated with LOD 0.

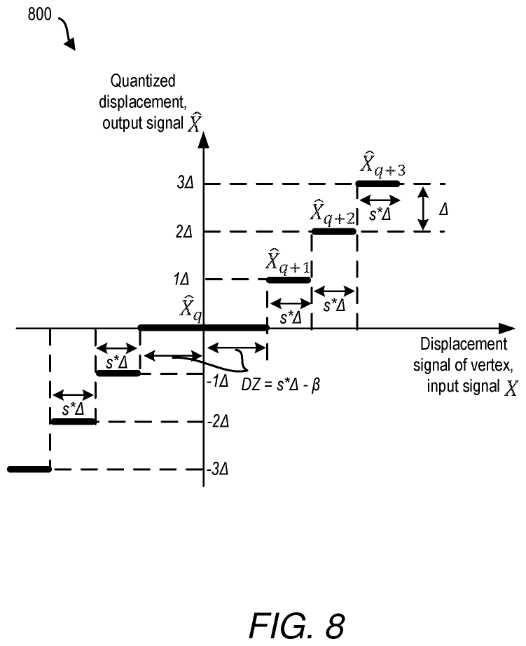

FIG. 8 illustrates an example diagram 800 of a quantizer to quantize transformed wavelet coefficients (as shown on the x-axis) representing displacements of a 3D mesh, according to some embodiments. The quantizer may be applied by an encoder (e.g., quantizer 212 of FIG. 2A and FIG. 2B). The quantizer quantizes the transformed wavelet coefficients of a 3D mesh into quantized values (e.g., integer values), according to some embodiments.

As shown in diagram 800, the quantizer may be a dead-zone quantizer having: a dead zone surrounding the quantized value of 0 with a width related to a dead-zone parameter (DZ), and quantization steps A with a size equal to a scaling factor s (e.g., a quantization scaling factor). The width of this dead zone may be determined or indicated by the dead-zone parameter (DZ), e.g., the width being 2*DZ. In some examples, the width of this dead zone may be determined according to the scaling factor s and a dead-zone offset/bias value β, represented by sΔ−β (or alternatively sΔ+β) where the quantized steps A are integer value and other quantization steps have a uniform width represented by s*Δ.

In some examples, the scaling value s and/or the dead-zone parameter DZ may be associated with each LOD of LODs associated with vertices of a 3D mesh.

The quantizer may convert an input signal X and convert (e.g., quantize) it to an output signal \hat{X}. For 3D mesh encoding, the input signal X may be a displacement signal of a vertex (e.g., a transformed coefficient representing the displacement of the vertex) and the output signal \hat{X} may be the quantized displacement signal (e.g., the quantized transform coefficient). For example, the quantizer may maintain a sign of the input signal X as the sign of the output signal \hat{X}. In some examples, the input signal X may be adjusted (e.g., added if the dead zone is represented by sΔ−β or alternatively subtracted if the dead zone is represented by sΔ+β) and scaled according to the scaling factor s (e.g., divided by s). The quantizer may apply a floor function (or alternatively a ceiling function) to the value of the scaled, adjusted input signal X to determine the output signal \hat{X} as the smallest integer less than or equal to that value. Alternatively, if a ceiling function were applied, quantizer may determine the output signal \hat{X} as the smallest integer greater than or equal to that value. For example, if β is 0 and s is equal to 2, then a set of input signals 0, 2.5, 3.7, 6.8 may be quantized to respective output signals 0, 1, 1, 3.

Accordingly, the quantizer may quantize the input signals X into quantized signals \hat{X}_{q}, \hat{X}_{q+1}, \hat{X}_{q+2}, \hat{X}_{q+3}, etc. depending on a range of values in which the input signals X fall. The selection of the s and β values may determine the width of the dead-zone and how many signals that have the value in this range/width are quantized to the value \hat{X}_{q} associated with the dead-zone (e.g., \hat{X}_{q}=0). The selection of s may determine the width of a quantization step and how many signals that have the value in this range of values (outside of the dead zone) are quantized to the non-zero values. For example, inputs values in range \hat{X}_{q+1} to \hat{X}_{q+2} are quantized to 1Δ (e.g., 1). For example, inputs values in range \hat{X}_{q+2} to \hat{X}_{q+3} are quantized to 2Δ (e.g., 2), etc.

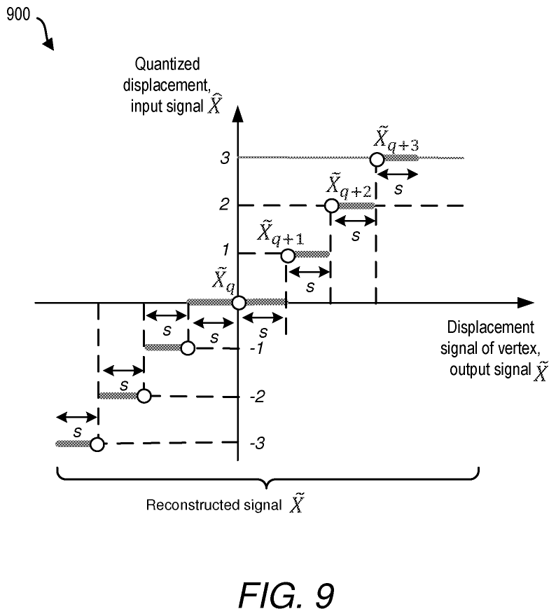

FIG. 9 illustrates an example diagram 900 of an inverse quantizer to inverse quantize quantized-transformed wavelet coefficients (as shown on the y-axis) representing displacements of a 3D mesh, according to some embodiments. The inverse quantizer may be applied by a decoder (e.g., inverse quantizer 222 of FIG. 2A and FIG. 2B, or inverse quantizer 312 of FIG. 3). The quantizer quantizes the transformed wavelet coefficients of a 3D mesh into quantized values (e.g., integer values), according to some embodiments. The inverse quantizer may be an example of a dead-zone inverse quantizer corresponding to the dead-zone quantizer, described in FIG. 8. The dead-zone inverse quantizer may be associated with an LOD, of a plurality of LODs, and/or quantization parameters that specify different levels of precision (e.g., or intensity) of the signal to be inverse quantized. The inverse quantizer may take an input signal \hat{X} (corresponding to the quantized displacement signal \hat{X} of FIG. 8) and apply inverse scaling using an inverse scaling factor (e.g., based on the scaling factor s in FIG. 8) and output the inverse-scaled value as output signal \hat{X}. For example, the input signal may be multiplied by the scaling factor s, which corresponds to an inverse of the inverse scaling factor. In some examples, the input signal \hat{X} is a quantized integer value that, after being inverse scaled, may become a value in floating/double precision. Due to the error introduced by quantization at the encoder as described in FIG. 8, the output signal \hat{X} approximates the original input signal X quantized by the encoder.

In some examples, the inverse quantizer may inverse quantize an input signal \hat{X} into one of inverse-quantized signals \hat{X}_{q}, \hat{X}_{q+1}, \hat{X}_{q+2}, \hat{X}_{q+3}, etc., which may be considered as a reconstruction point representing that inverse quantization level.

In existing technologies, as described above with respect to FIG. 9, an inverse quantizer applies only an inverse scaling factor regardless of whether the quantizer, for quantizing displacement signals for vertices of a 3D mesh, is a dead-zone quantizer or a uniform quantizer. By inverse quantizing the quantized signal \hat{X}, the inverse-quantized (e.g., reconstructed) signal (e.g., \hat{X}_{q}, \hat{X}_{q+1}, \hat{X}_{q+2}, \hat{X}_{q+3}) corresponds to a vertex (of the original 3D mesh) whose position is in a certain range, associated with a scaling factor (e.g., a width of the quantization step). However, this inverse-quantized value may be a poor approximation (or representation) of unquantized signals X falling in a range of values associated with a scaling factor. For example, the input signals X may contain 5 values between 1 and 2: 1.2, 1.3, 1.5, 0.9, and 1.6. If a scaling factor of 1.0 is applied, all 5 values may be quantized to 1.0 and reconstructed as a value of 1.0. The statistics of the displacement signals within this example quantization range (e.g., 1-2) may indicate an average value of the five signals of X of 1.3. Accordingly, an average error (and corresponding decrease in quality) of 0.3 is introduced between the average of the five input signals X and the average of the quantized (and inverse quantized) value of 1.0

Embodiments of the present disclosure are related to applying quantization offsets during inverse quantization of quantized wavelet coefficients representing displacements of vertices of a 3D mesh (e.g., a mesh frame). In some examples, a decoder may decode, from a bitstream, a quantized wavelet coefficient representing a displacement of a vertex from a set of the vertices. Quantization information indicating a quantization offset associated with a subset of vertices of the set of vertices may be decoded from the bitstream. Then, a wavelet coefficient (corresponding to an inverse quantized wavelet coefficient) may be determined as the displacement of the vertex, based on the quantization offset being associated with the subset in which the vertex belongs. By applying the quantization offset (e.g., a reconstruction bias/offset/adjustment) to subsets of vertices, more accurate displacements may be reconstructed or achieved. For example, in the above examples in which an average error for five signals is determined to be 0.3, the quantization offset may be indicated as 0.3 such that an average of the inverse quantized signals is equal to an average of the original signals.

In some embodiments, the quantization offset may be applied to an inverse quantized value. For example, the decoder may inverse quantize the quantized wavelet coefficient to determine a wavelet coefficient. Then, the decoder may adjust, based on the vertex being in the subset, the wavelet coefficient according to the quantization offset to determine the displacement of the vertex. In some examples, the quantization offset may be determined for the subset within a current mesh frame (i.e., current 3D mesh frame). For example, a respective quantization offset may be determined for each subset of vertices of the current mesh frame. Separate quantization offsets may be determined for each subset per mesh frame.

In some embodiments, the quantization offset may be applied to a quantized value. For example, the decoder may adjust, based on the vertex being in the subset, the quantized wavelet coefficient according to the quantization offset. Then, the decoder may determine the displacement of the vertex based on inverse quantizing the adjusted, quantized wavelet coefficient.

In some examples, the set of vertices includes non-overlapping subsets of vertices, and the quantization information may be signaled (e.g., decoded) for each subset. For example, the subset may include vertices of a same LOD of LODs. In this example, prediction/reconstruction error between inverse quantized signals and original signals within each LOD may be reduced based on decoding the quantization offset per LOD. In other examples, the subset may include vertices in a sub-mesh of the 3D mesh, a patch group of the sub-mesh or the 3D mesh, or a patch of the patch group.

In some examples, an indication (e.g., a mode indication, a flag, a syntax element) of whether quantization adjustment is enabled is decoded for the subset of vertices. The decoder may further decode the quantization information indicating the quantization offset based on the indication that quantization adjustment is enabled.

These and other embodiments are described herein.

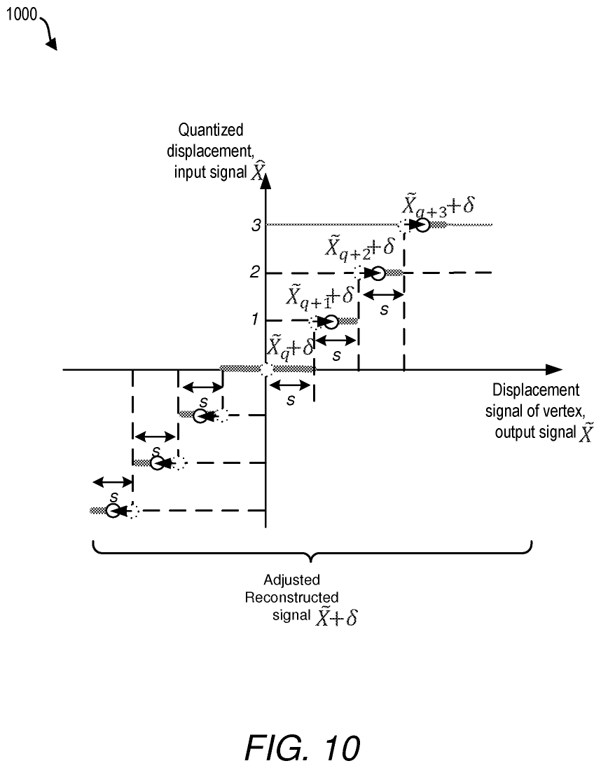

FIG. 10 illustrates an example diagram 1000 of an inverse quantizer with a quantization offset (S) and an inverse quantization scaling factor (s) to inverse quantize (e.g., inverse scale) quantized-transformed wavelet coefficients representing displacements of a 3D mesh, according to some embodiments. The 3D mesh may be processed as a sequence of mesh frames. The inverse quantizer of diagram 1000 may inverse the operations of a quantizer at an encoder, such as that described in FIG. 8. The inverse quantizer may be applied by a decoder (e.g., inverse quantizer 222 of FIG. 2A and FIG. 2B, or inverse quantizer 312 of FIG. 3).

In some examples, the quantization offset and one or more parameters used to derive the inverse quantization scaling factor may be determined (and decoded) by the decoder for each subset of a set of vertices of the 3D mesh. In some examples, the quantization offset and the one or more parameters may be determined per subset of vertices per mesh frame of the sequence of mesh frames. For example, the subset of vertices may correspond to vertices in the same LOD (or alternatively the same sub-mesh, patch group, patch, tile, etc.) of a current mesh frame. As explained above, selectively enabling quantization adjustment and signaling (e.g., decoding) indications of quantization offsets associated each subset of vertices may improve statistics of inverse quantized wavelet to be closer to statistics of the original un-quantized wavelet coefficients, thus achieving less distortion (e.g., improved quality). These benefits may be achieved independent of whether the inverse quantizer is a uniform inverse quantizer or a dead-zone inverse quantizer because the quantization errors are more impacted by the scaling factor (and inverse scaling factor) than a width of a dead zone in a dead-zone quantizer (and corresponding dead-zone inverse quantizer).

As shown in the reconstruction adjustment process of diagram 1000, which may be applicable to the subset of vertices, an input quantized signal \hat{X} (e.g., the quantized displacement output signal \hat{X} of FIG. 8) may be adjusted (e.g., shifted or biased) to a value equal to a multiple of the scaling factor s plus the quantization offset (δ). In some examples, the input quantized signal \hat{X} may be inverse scaled first before being adjusted with the quantization offset δ, and quantization offset δ may represent an offset value scaled by the scaling factor s. In other examples, the quantization offset δ may be applied to the input quantized signal \hat{X} before being inverse quantized according to the scaling factor (s) or corresponding inverse scaling factor (e.g., 1/s).

In diagram 1000, the quantization offset δ is shown as being added to a magnitude of the inverse quantized signal \hat{X} derived from the input quantized signal \hat{X}. In other examples, the quantization offset δ may be added directly to the inverse quantized input signal \hat{X}.

In some examples, a respective quantization offset δ is associated each subset of vertices, such as vertices in the same LOD, and this same quantization offset value S may be applied to the vertices in this subset. In some examples, the quantization offset δ being set to zero represents the disabling of the quantization adjustment (e.g., reconstruction point offset adjustment process) associated with wavelet coefficients corresponding to the subset of vertices. For example, the quantization offset δ may be set to zero for an inverse quantized value (shown as output signal \hat{X}) of 0. This inverse quantized value of 0 corresponds to values in the dead zone region as computed at the encoder, as shown in FIG. 8.

As explained above, the quantization offset δ may be computed by an encoder and signaled to the decoder to correct for the loss of detail due to quantizers being applied to displacements for the vertices. Generally, some subsets such as higher LODs when subsets are LODs, larger quantizers (e.g., with larger scaling factors s) are used. For larger quantizers, the quantization offset δ is used to adjust for details lost due to quantization. But, larger quantizers may result in displacements in a larger range of values being quantized to the same value, which may lead to unnecessarily large quantization offset δ values. Accordingly, in some embodiments, the quantization offset δ may be further adjusted by an offset adjustment value (a₆).

In some examples, the quantization offset δ may be further adjusted by adding offset adjustment value (a_{δ}). For example, a respective offset adjustment value (a_{δ}) may be determined for each subset of vertices. For example, the offset adjustment value (a_{δ}) may be determined based on subtracting two offset values between two subsets of vertices, such as between two offset values determined for two consecutive LODs. For a current LOD, the consecutive LOD may be either the next higher LOD or in, an example, the next lower LOD. based on the specific subset.

In some examples, the quantization offset δ may be further adjusted by a product of the quantization offset δ with the offset adjustment value (a_{δ}). For example, the offset adjustment value (a_{δ}) may be a scaling factor determined based on an amount of quantization associated with the subset of vertices. For example, the scaling factor may be determined based on an LOD, which is associated with specific quantizers. In some examples, the scaling factor may be determined to be inversely proportional to a level of the LOD. As an example, the inversely proportional relationship may be a negative power of two where the power is based on a level of the LOD. In this example, for LOD0, LOD1, and LOD2, the example respective scaling factors may be 2\hat{ }(−0)=1, 2\hat{ }(−1)=0.5, and 2\hat{ }(−2)=0.25. The effect of the offset adjustment value (a_{δ}) is to apply larger reductions to the quantization offset δ for subsets of vertices with larger quantizers, such as higher LODs.

In some embodiments, to prevent skewed distributions or outliers of displacement values within a range of values being quantized to the same value resulting in a high quantization offset δ, the quantization offset δ may be limited such that it does not exceed a predetermined threshold value. For example, the quantization offset δ (with or without the offset adjustment value (a_{δ})) may be compared to a threshold value δₘₐₓ such that values of quantization offset δ higher than the threshold value δₘₐₓ are set to the threshold value δₘₐₓ. In some examples, the quantization offset δ may also be compared to a threshold value δₘᵢₙ such that values of quantization offset δ lower than the threshold value δₘᵢₙ are set to the threshold value δₘᵢₙ. For example, the range of values of quantization offset δ may be set as [δₘᵢₙ, δₘₐₓ]. In some examples, the magnitude of δₘₐₓ may be the same as the magnitude of the minimum value using δₘᵢₙ.

In some examples, the quantization offset δ may be first adjusted by the offset adjustment value (a_{δ}) before being compared to threshold value δₘₐₓ and/or δₘᵢₙ and only when it exceeds the limit set by the threshold value δmₐₓ or δₘᵢₙ.

In some examples, the quantization offset δ may be compared with the threshold value δₘₐₓ and/or δₘᵢₙ, but instead of limiting the quantization offset δ to these values, the quantization offset δ may be adjusted by the offset adjustment value (a_{δ}) based on (e.g., in response to) exceeding one of the threshold values δₘₐₓ and/or δₘᵢₙ. In other examples, the threshold values used to determine whether to apply offset adjustment value (a_{δ}) are different than the threshold values used to restrict the possible values of the quantization offset δ.

In some embodiments, the adjustments and/or thresholds applied to the quantization offset δ may be performed the same way at the encoder and the decoder. For example, the encoder may signal one or more indications (e.g., flags) that enable the adjustment, the applied thresholds, or a combination thereof. In other embodiments, the encoder may apply the adjustments and/or thresholds to the quantization offset δ to determine a final quantization offset δ, for a subset of vertices, that is signaled in the bitstream to the decoder. In such embodiments, processing for deriving the final quantization offset δ is shifted to the encoder to reduce the computational complexity required at the decoder.

In some embodiments, the quantization offset δ may be signaled by the encoder to the decoder for each subset of vertices.

In some embodiments, the quantization offset δ may be derived based on a quantization level associated with the subset of vertices such that it need not be explicitly signaled in the bitstream from the encoder to the decoder. For example, the encoder and the decoder may separately and identically compute the quantization offset δ for the vertices of the subset based on the LOD (e.g., an index of the LOD) associated with that subset. For example, quantization offset δ may be determined based on a quantization scaling factor determined based on the index of the LOD.

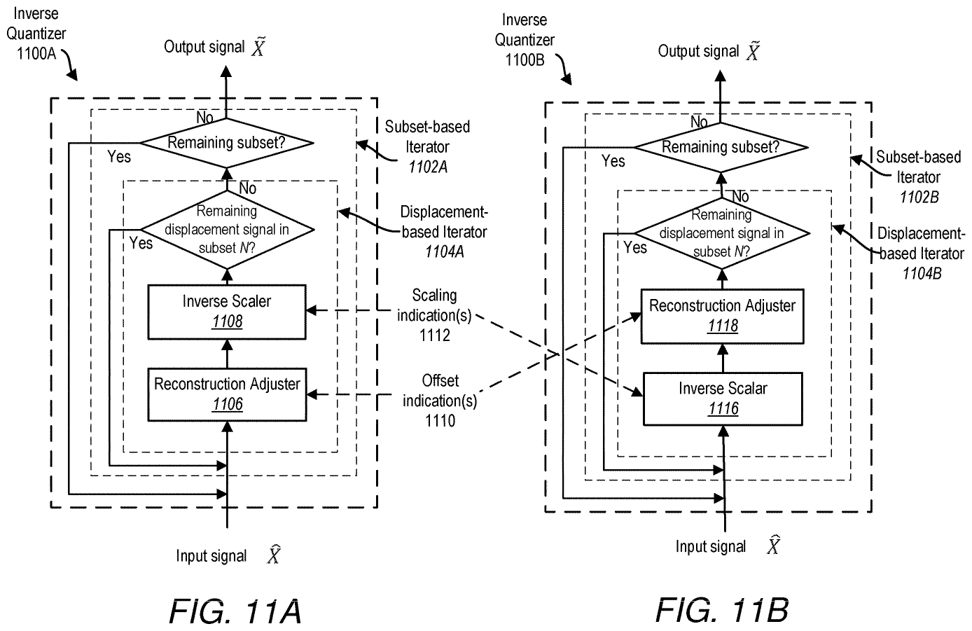

FIG. 11A is a diagram that illustrates an example process of an inverse quantizer 1100A for iteratively inverse quantizing quantized-transformed wavelet coefficients of vertices in each subset of vertices of the 3D mesh, according to some embodiments. Operations of inverse quantizer 1100A may be applied by a decoder (e.g., inverse quantizer 222 of FIG. 2A and FIG. 2B, or inverse quantizer 312 of FIG. 3). Inverse quantizer 1100A performs inverse quantization scheme with a reconstruction adjustment process, according to some embodiments. Inverse quantizer 1100A may be a dead-zone inverse quantizer, as explained above in FIG. 10.

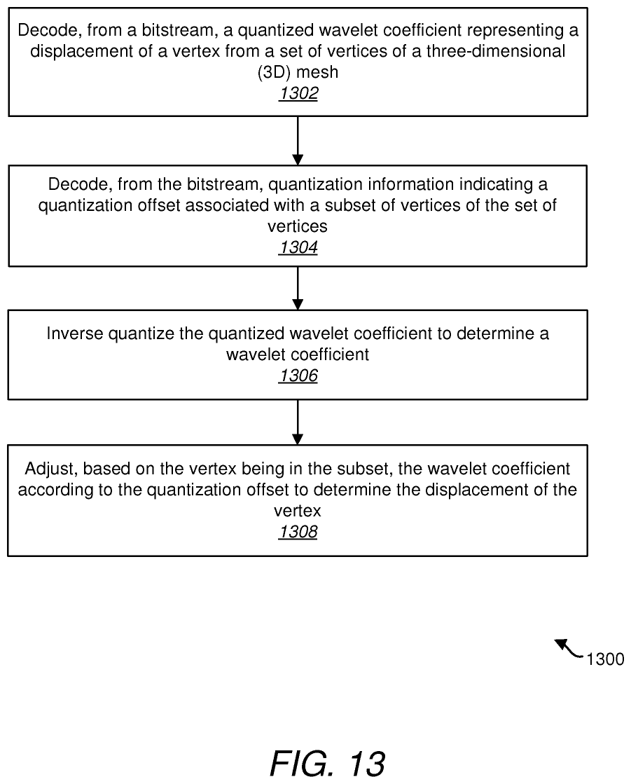

In some examples, such as that performed by quantizer 212 of FIGS. 2A-B, the quantization processes are iteratively applied (e.g., performed) to wavelet coefficient signals per subset of vertices (e.g., from vertices at higher LODs to vertices at lower LODs). To inverse the operations of the quantization processes, inverse quantizer 1100A iteratively perform inverse quantization per subset of vertices as shown in subset-based iterator 1102A (e.g., from vertices at lower LODs to vertices at higher LODs). For quantized wavelet coefficients of vertices in each subset, inverse quantizer 1100A iteratively performs inverse quantization for each of the wavelet coefficients in the subset, as shown by displacement-based iterator 1104. Once all wavelet coefficients in a subset have been inverse quantized, inverse quantizer 1100A inverse quantizes wavelet coefficients in a next subset. Within each inverse quantization operation, inverse quantizer 1100A may include a reconstruction adjuster 1106 and an inverse scaler 1108. Reconstruction adjuster 1106 may apply a quantization offset indicated by offset indication(s) 1110, as explained above in FIG. 10 and further detailed below with respect to FIG. 13. Inverse scaler 1108 may apply an inverse scaling factor indicated by scaling indication(s) 1112, as explained above in FIG. 10 and further detailed below with respect to FIG. 13.

In some examples, when subsets of a set of the vertices of the 3D mesh correspond to different LODs of a plurality of LODs of the vertices, inverse quantizer 1100A may iteratively inverse quantize signal samples (e.g., displacement signals and corresponding quantized-transformed wavelet coefficient representations) from lower LODs to higher LODs. For example, in each iteration, a next input signal \hat{X} (e.g., input signal \hat{X} of FIG. 10) associated with an LOD is converted (e.g., inverse quantized according to a quantization offset) to an output signal A, which is an inverse-quantized coefficient representation of a displacement for the vertex. Subset-based iterator 1102A iterates for each higher LOD until the highest LOD level is processed at which point all quantized wavelet coefficient signals (e.g., input signal \hat{X}) will have been inverse-quantized (e.g., input signal \hat{X}). For example, a base mesh of 900 vertices may be subdivided into an up-sampled mesh with, e.g., 57,600 vertices across 4 LOD levels (e.g., LOD₀ comprising vertices with indexes 1-900, LOD₁ comprising vertices with indexes 901-3600, LOD₂ comprising vertices with indexes 3601-14400, and LOD₃ comprising vertices with indexes 14401-57600). In this example, the associated displacements (e.g., displacement values and quantized wavelet coefficient representations) have the same order as these vertices. In this example, inverse quantizer 1100A may start from the lowest LOD, which may be LOD₀.

In some embodiments, reconstruction adjuster 1106 may determine whether to apply quantization adjustment (e.g., reconstruction adjustment) based on a first indication, of offset indication(s) 1110, received (e.g., decoded) from a bitstream. For example, the first indication may be received (e.g., decoded) and associated with each subset of vertices. In some examples, when subsets correspond to LODs, offset indication(s) 1110 may further indicate an LOD index (indicating a specific LOD) and whether the quantization adjustment operation (e.g., reconstruction adjustment operation) of reconstruction adjuster 1106 is enabled for that LOD index. When the first indication indicates that reconstruction adjuster 1106 is enabled, offset indication(s) 1100 may further include a second indication of the quantization offset used in the quantization adjustment operation corresponding to the LOD.

In some embodiments, reconstruction adjuster 1106 is enabled by default, in which case the first indication is not signaled and only the second indication is signaled. In these embodiments, the quantization offset for a subset of vertices (e.g., a specific LOD) may be signaled as being equal to zero, which has the same effect as the quantization offset being disabled or not used for vertices of that subset.

In some examples, the first indication may be signaled for the 3D mesh (e.g., a mesh frame) or a sequence of mesh frames. In some examples, based on the first indication indicating that the quantization adjustment operation is enabled, reconstruction adjuster 1106 may determine (e.g., set) the same quantization offset across all subsets (e.g., LODs) according to the second indication. In other examples, based on the first indication indicating that the quantization adjustment operation is enabled, reconstruction adjuster 1106 may determine (e.g., set) a quantization offset for each subset (e.g., LODs) according to the second indication that is decoded for that specific subset.

In some embodiments, offset indication(s) 1100 may include the first indication and/or the second indication signaled by the encoder to the decoder. For example, as explained above in FIG. 8, the encoder may generate and signal (e.g., encode), in a bitstream, offset indication(s) 1110 based on comparing compression results between one or more inverse quantization processes, corresponding to one or more subsets, being disabled and enabled. For example, the encoder may signal offset indication(s) 1100 to the decoder to enable/disable reconstruction adjuster 1106 associated with each subset of vertices to minimize the inverse quantization error (e.g., maximizes compression gains). Accordingly, inverse quantizer 1100A (e.g., of a decoder) may apply (e.g., implement and/or perform) operations of reconstruction adjuster 1106 according to offset indication(s) 1110 signaled by the encoder. Based on quantization adjustment being disabled for wavelet coefficients associated with a subset of vertices, inverse quantizer 1100A may skip (e.g., omit) reconstruction adjuster 1106 and inverse scaler 1108 may directly perform inverse quantization (e. g., inverse scaling) for quantized wavelet coefficient signals of vertices corresponding to that subset (e.g., at LOD_{N}).

In some examples, offset indication(s) 1100 comprises a single indication that indicates whether to enable (e.g., disable or skip) the quantization adjustment for all LODs of the 3D mesh or a sequence of mesh frames. In some examples, offset indication(s) 1100 comprises a single indication that indicates one of the LODs whose corresponding quantized wavelet coefficients are to be adjusted (or not adjusted) in the quantization adjustment process. For example, the single indication may indicate the lowest LOD level (e.g., last LOD or LOD₀), corresponding to the coarsest resolution, whose associated quantization adjustment operation is to be disabled. This may be useful because the inverse quantization in that LOD is with a lower quantization level and the reconstructed signal may be an accurate enough representation of the original uncompressed signal.

In some examples, offset indication(s) 1100 comprises an indication for each respective LOD of the LODs associated with vertices of the mesh frame. For example, one indication for one LOD may indicate whether quantization adjustment operation for that LOD should be enabled or disabled. At the encoder, the encoder may compare compression results between the quantization adjustment for the LOD being enabled and disabled to determine whether the indication of the quantization adjustment operation signaled, in a bitstream, to the decoder is enabled or disabled. Then, the decoder may decode the indication, from the bitstream, for the corresponding LOD and selectively perform the quantization adjustment operation (of reconstruction adjuster 1106) for wavelet coefficients of the LOD according to the indication.

In some examples, offset indication(s) 1100 comprises an indication for each respective LOD of the LODs associated with vertices of the mesh frame. But, instead of the encoder comparing compression results between the quantization adjustment operation for the LOD being enabled and disabled to determine whether the indication of the quantization adjustment operation signaled, the encoder may compare compression results between enabling/disabling sets of reconstruction adjustment operations, corresponding to LODs, to determine a combination of indications that increases (e.g., maximizes) compression gains. Similarly, although the above examples are described with respect to LODs, they may similarly be applied to subsets (which are not necessarily LODs).

In some examples, an indication of offset indication(s) 1100 may indicate an LOD index identifying an LOD, of LODs of the mesh frame, for which quantization adjustment is enabled/disabled based on the indication. For example, the indication may include the LOD index and a binary indication (e.g., binary flag) whose value indicates enabling/disabling of the quantization adjustment operation corresponding to the LOD index.

In some examples, offset indication(s) 1100 may be signaled per sequence of 3D mesh frames, per mesh frame, per tile, per patch, per patch group, or per LOD. In some examples, one or more indications comprises an indication that may be signaled per LOD in a mesh frame.

In some embodiments, the first indication (e.g., mode indication) indicating whether quantization adjustment operation is enabled/disabled for each subset of vertices is not signaled between the encoder and the decoder and is predetermined. For example, quantization adjustment operation for wavelet coefficient signals of vertices at all LODs may be enabled without being signaled in offset indication(s) 1100.

In some embodiments, offset indication(s) 1100 may include a second indication (e.g., a flag, or a syntax element) signaled in the bitstream indicating the quantization offset used by reconstruction adjuster 1106 to determine (e.g., derive or compute) an adjusted quantized wavelet coefficient (e.g., input signal 9). For example, the second indication may indicate an index to a set of quantization offsets to specify one of the quantization offsets, or a specific value, or an exponent of a specific value (e.g., the value n represents the exponent of the 2ⁿ). In some examples, the second indication may be signaled per sequence of 3D meshes, per mesh frame, per tile, per patch, per patch group, per LOD, etc.

In some embodiments, offset indication(s) 1110 may include a third indication (e.g., a flag, or a syntax element) signaled in the bitstream indicating the quantization offset used by reconstruction adjuster 1106 to determine (e.g., derive or compute) an adjusted quantization offset value for adjusted quantized wavelet coefficient (e.g., input signal 9). For example, the third indication may indicate an index to a set of offsets, or an exponent of a specific value (e.g., the value n represents the exponent of the 2ⁿ) to adjust one of the quantization offsets.

In some examples, the inverse scaler 1108 may determine an inverse scaling factor according to scaling indication(s) 1112. For example, scaling indication(s) 1112 may include one or more scaling parameters such as a quantization parameter (qp) and/or a bit-depth parameter (BDP), as will be further described below in FIG. 13. In some examples, the one or more scaling parameters may be signaled for (and associated with) each subset of vertices (e.g., corresponding to the same LOD, or in a same sequence of 3D meshes, in a sub-mesh of the 3D mesh, in a same patch (or patch group) of the sub-mesh or the 3D mesh, etc.). In some examples, the scaling parameters may be derived between the subsets of vertices (e.g., scaled by a fixed-ratio value).

In some embodiments, scaling indication(s) 1112 may include one or more indications indicating whether the quantization parameter (qp) and/or a bit-depth parameter (BDP) are signaled (e.g., present) in the bitstream. For example, the one or more indications may be signaled for each subset of vertices. Similar to how the encoder may determine whether offset indication(s) should enable/disable quantization adjustment, the encoder may determine the one or more indications indicating whether the quantization parameter (qp) and/or a bit-depth parameter (BDP) are signaled (e.g., present) in the bitstream. Default values for quantization parameter (qp) and/or a bit-depth parameter (BDP) may be used if the one or more indications indicate those parameters being absent (i.e., not signaled in the bitstream).

FIG. 11B is a diagram that illustrates an example process of an inverse quantizer 1100B for iteratively inverse quantizing quantized-transformed wavelet coefficients of vertices in each subset of vertices of the 3D mesh, according to some embodiments. Operations of inverse quantizer 1100B may be applied by a decoder (e.g., inverse quantizer 222 of FIG. 2A and FIG. 2B, or inverse quantizer 312 of FIG. 3). Inverse quantizer 1100B performs inverse quantization scheme with a reconstruction adjustment process, according to some embodiments. Inverse quantizer 1100B may be a dead-zone inverse quantizer, as explained above in FIG. 10. Much like subset-based iterator 1102A and displacement-based iterator 1104A, inverse quantizer 1100B includes corresponding subset-based iterator 1102B and displacement-based iterator 1104B, respectively. Different from inverse quantizer 1100A, inverse quantizer 1100B may include an inverse scalar 1116 and reconstruction adjuster 1118 that reverse the sequencer (e.g., order) of operations performed by reconstruction adjuster 1106 and inverse scaler 1108, as will be further explained below in FIG. 13. Similar to inverse quantizer 1100A, inverse scaler 1116 may operate according to scaling indication(s) 1112 and similar to reconstruction adjuster 1106, reconstruction adjuster 1118 may operate according to offset indication(s) 1110.

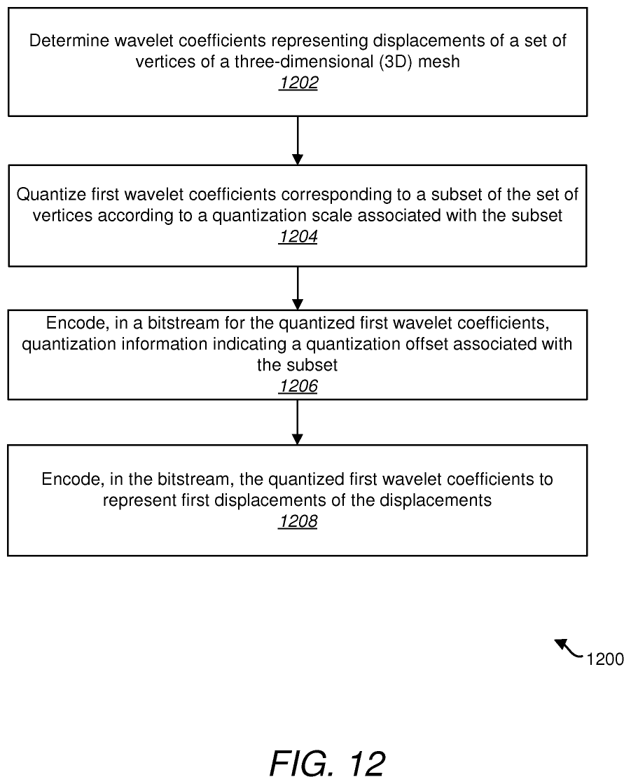

FIG. 12 illustrates a flowchart 1200 of a method for applying a quantization scheme to transformed wavelet coefficients, according to some embodiments. In some examples, the method may be performed by an encoder (e.g., encoder 114 of FIG. 1, encoder 200A of FIG. 2A, or encoder 200B of FIG. 2B). The following descriptions of various steps may refer to operations described above with respect to quantizer 212 of FIG. 2A, or quantizer 212 of FIG. 2B.

At block 1202, the encoder determines wavelet coefficients representing displacements of a set of vertices of a three-dimensional (3D) mesh. For example, the wavelet coefficients may be determined by a wavelet transformer (e.g., wavelet transformer 210 of FIG. 2A or FIG. 2B) of the encoder. As explained above, the encoder may convert (e.g., transform) the determined displacements of the set of vertices to the wavelet coefficients according to a wavelet transform (e.g., a wavelet transform lifting scheme).

At block 1204, the encoder quantizes first wavelet coefficients corresponding to a subset of the set of vertices according to a quantization scaling factor (e.g., associated with a quantization size s in FIGS. 8-10, and may be referred to as a scaling factor) associated with the subset. In some examples, a quantization scaling factor is determined for each subset of non-overlapping subsets of the set of vertices. Then, wavelet coefficients corresponding to vertices in each of the subset may be quantized according to a respective quantization scaling factor associated with that subset. For example, a subset of vertices may comprise vertices at a same LOD of a plurality of LODs. For example, the subset of vertices may comprise vertices in a sub-mesh of the 3D mesh. For example, the subset of vertices may comprise vertices in a patch of the sub-mesh or 3D mesh.

In some examples, a wavelet coefficient (X representing an unquantized, original value) may be quantized to determine a quantized wavelet coefficient (\hat{X}) based on the quantization scaling factor (s_q) and possibly a dead zone offset (DZ), which may be based on dead zone bias parameter (β), as follows:

$$\hat{X} = sgn ( X ) * ⌊ ( \vert X \vert - DZ ) * s\_q + 1 ⌋ = sgn ( X ) * ⌊ \vert X \vert * s\_q + β ⌋$$

The sgn function is a sign function (e.g., a signum function) that outputs a sign of a wavelet coefficient (X) and the magnitude of X is shown as the absolute function IXI. If the dead zone offset is not used (or enabled), the dead zone offset (DZ) may be set to 0. The quantizer may apply a floor function (as shown above) to determine the smallest integer less than or equal to the wavelet coefficient scaled according to a dead zone offset (which may be optional). In other examples, the quantizer may apply a ceiling function to determine the smallest integer greater than or equal to the wavelet coefficient scaled according to a dead zone offset.

In some examples, the dead zone offset may be based on a dead zone bias parameter (β) indicating (e.g., corresponding) to the dead zone offset, which is also shown above (e.g., β=1+DZ*s). In some examples, dead zone bias parameter (β) may be negative. In some examples, the width of the dead zone offset may refer to DZ or the region surrounding 0, e.g., 2*DZ, as explained in FIG. 8.

In general, the quantization scaling factor (s_q) is a value between 0 (e.g., non-inclusive) and 1 (e.g., inclusive) such that the quantized wavelet coefficient will be a smaller value than an unquantized wavelet coefficient. The quantization scaling factor (s_q) may be the inverse of the quantization size (s=1/s_q), as shown in FIGS. 8-10. In some examples, the determined dead zone offset may be smaller than the quantization size (s or inverse quantization scaling factor).

In some examples, the quantization scaling factor (e.g., forward quantization scaling factor s_q) may be determined based on a quantization parameter (qp) and a bit-depth parameter (bitDepthPosition or BDP). For example, the quantization scaling factor (scale[d]) for a wavelet coefficient (e.g., representing a displacement signal d) may be determined as a power of two according to the following relationship:

$$scale [ d ] = qp >= 0 ? power ( 2. , 16 - BDP + ( 4 - qp ) / 6 ) : 0.$$

In some examples, the quantization parameter (qp) and/or the bit-depth parameter (BDP) may be determined and/or signaled (e.g., encoded in the bitstream) for each subset of the set of vertices. In some examples, the quantization parameter and/or the bit-depth parameter may be signaled for the 3D mesh (e.g., a 3D mesh frame) or a sequence of 3D meshes (e.g., including the 3D mesh).

In some examples, the quantization scaling factor may be determined as a fixed ratio between subsets (e.g., LODs) such that the quantization scaling factor is scaled (e.g., increased or decreased) according to the fixed ratio per subset. In some examples, quantization scaling factor, the quantization parameter, and/or the bit-depth parameter can be derived from a subset to other subset(s).

In some examples, a displacement may be represented as three components, in which case a quantization scaling factor may be applied to each component. In typical implementations, the quantization scaling factor may be determined to be the same for each component.

In some examples, the encoder iteratively quantizes wavelet coefficients of each subset of subsets of the set of vertices. For example, when each subset corresponds to vertices in a same LOD of LODs, the encoder may iteratively quantize wavelet coefficients per subset according to an order of the LODs (e.g., from higher LODs to lower LODs).

At block 1206, the encoder encodes, in a bitstream for the quantized first wavelet coefficients, quantization information indicating a quantization offset associated with the subset. In some examples, the quantization information may further indicate one or more parameters for quantization such as the quantization parameter and/or the bit-depth parameter. As explained above, the quantization information may be signaled for each subset of vertices.

In some examples, the encoder determines, based on differences between the first wavelet coefficients and the quantized first wavelet coefficients, the quantization offset associated with the subset. For example, the quantization offset may be determined as a measure of a center (e.g., an average, a median, a mode, etc.) of the differences. In some examples, the quantization information includes a respective quantization offset for each subset of non-overlapping subsets of the set of vertices, with the subset being one the non-overlapping subsets.

In some examples, the quantization information includes an indicator (e.g., one or more indicators, flags, or syntax elements) of the quantization offset. In some examples, the indicator may include a sign and a magnitude of the quantization offset.

In some examples, the indicator may include an index that selects the quantization offset from a plurality of quantization offsets. For example, the encoder may signal the plurality of quantization offsets in a list (e.g., array or table).

In some examples, the indicator (or indication) of the quantization offset may be entropy coded, e.g., using a unary code, a Rice code, a Golomb code, an Exp-Golomb code, or the like.

In some examples, the quantization information comprises an indication of whether quantization adjustment is enabled (e.g., selectively enable or disable quantization adjustment per subset of vertices) for each subset of the (non-overlapping) subsets of vertices. For example, if a subset corresponds to one mesh frame (e.g., the 3D mesh) in a sequence of mesh frames, the indication may be signaled per mesh frame. For example, if a subset corresponds to an LOD, the indication may be signaled per LOD. For example, the indication (e.g., mode indication for quantization adjustment) may be signaled per sequence of 3D mesh frames, per mesh frame, per sub-mesh, per tile, per patch group, per patch, and/or per LOD.

In some examples, the encoder may compare compression results (e.g., a rate distortion optimization (RDO) cost) of the inverse quantization between the quantization adjustment operations (e.g., as explained above in FIG. 10, FIGS. 11A-11B, and below in FIG. 13), corresponding to the subset, being disabled and enabled to determine the indication. For example, if compression gain is increased (e.g., fewer bits being required to be generated in displacement bitstream 260) with the quantization adjustment operation (e.g., also referred to as inverse quantization adjustment or reconstruction adjustment) being enabled, the encoder may determine the indication of the quantization adjustment operation as being enabled and further indicate, in the quantization information, a second indication of the quantization offset. For example, the indication of quantization adjustment may indicate whether reconstruction adjuster (e.g., reconstruction adjuster 1106 of FIG. 11A or reconstruction adjuster 1118 of FIG. 11B at the decoder) are enabled. If quantization adjustment is disabled (by the indication), operations of the reconstruction adjuster may be disabled.

In some examples, the indication of the quantization adjustment operation may be entropy coded, e.g., using a unary code, a Rice code, a Golomb code, an Exp-Golomb code, or the like.

In some examples, the encoder may signal an indication of the dead zone offset (e.g., a value of DZ, or a dead zone bias parameter (β)) in the quantization information. In some examples, the indication of the dead zone offset may be entropy coded, e.g., using a unary code, a Rice code, a Golomb code, an Exp-Golomb code, or the like.

In some examples, the encoder further signals an indication of whether an offset adjustment value (a_{δ}) is applied to the quantization offset, as explained in FIG. 10. In some examples, the encoder may signal an indication of whether one or more threshold values are applied to the quantization offset, as explained in FIG. 10. In other examples, the quantization offset, signaled by the encoder to the decoder, is determined according to applying offset adjustment value (a_{δ}) and/or the one or more threshold values such that no further indications are signaled in the bitstream.

At block 1208, the encoder encodes, in the bitstream, the quantized first wavelet coefficients to represent first displacements of the displacements. As explained above, the encoder may quantize wavelet coefficients corresponding to each of the subsets of vertices. Then, the encoder may encode the quantized wavelet coefficients for each of the subsets of vertices.

In some examples, the encoder may signal (e.g., encode) the quantized wavelet coefficients representing displacements of the set of vertices in 2D images. For example, the wavelet coefficients for the vertices of the 3D mesh may be arranged (e.g., packed) by an image packer (e.g., image packer 214 of FIG. 2A and FIG. 2B) into a 2D image (e.g., displacement image 720 in FIG. 7A). In some examples, the wavelet coefficients may be quantized by a quantizer (e.g., quantizer 212 of FIG. 2A and FIG. 2B) before being arranged by the image packer, as described in FIG. 2A and FIG. 2B. Further, the 2D images may be encoded by a 2D video codec such as video encoder 216 described in FIG. 2A and FIG. 2B.

FIG. 13 illustrates a flowchart 1300 of a method for applying an inverse quantization scheme to quantized-transformed wavelet coefficients, according to some embodiments. In some examples, the method may be performed by decoder (e.g., decoder 120 of FIG. 1 or decoder 300 of FIG. 3). The following descriptions of various steps may refer to operations described above with respect to inverse quantizer 222 of FIG. 2A and FIG. 2B, or inverse quantizer 312 of FIG. 3.

At block 1302, the decoder decodes, from a bitstream, a quantized wavelet coefficient representing a displacement of a vertex from a set of vertices of a three-dimensional (3D) mesh. As explained above with respect to FIG. 11A and FIG. 11B, the decoder may similarly receive and decode quantized wavelet coefficients representing displacements (including the displacement of the vertex) of the set of vertices.

In some examples, the set of vertices are ordered according to levels of detail (LODs) of the vertices, and the quantized wavelet coefficients may be decoded from the bitstream according to LODs. For example, the decoder may apply, in the order, an inverse wavelet transform (e.g., an inverse lifting scheme) to transformed wavelet coefficients, received in the bitstream, to determine (non-transformed) quantized wavelet coefficients including the quantized wavelet coefficient.

In some examples, the quantized wavelet coefficients are decoded based on decoding, from the bitstream, an image (e.g., a 2D image) including transformed wavelet coefficients. The decoder may determine the transformed wavelet coefficients, from the decoded image, according to a packing order of wavelet coefficients in the image. For example, as explained above in FIG. 12, the quantized wavelet coefficients are arranged (e.g., packed) by an image packer at the encoder into a 2D image (e.g., displacement image 720 in FIG. 7A). Accordingly, the decoder may include a video decoder (e.g., video decoder 308 of FIG. 3) that decodes the 2D image containing the quantized wavelet coefficients. The decoder may include an image unpacker (e.g., image unpacker 310 of FIG. 3) to reverse (e.g., unpack) operation of the image packer to determine a sequence of quantized wavelet coefficients. In some examples, the decoder may include an inverse quantizer (e.g., inverse quantizer 312) to inverse quantize the unpacked first wavelet coefficients.

At block 1304, the decoder decodes, from the bitstream, quantization information indicating a quantization offset associated with a subset of vertices of the set of vertices. In some embodiments, the set of vertices includes non-overlapping subsets of vertices with the subset being one of the non-overlapping subsets. In some examples, the non-overlapping subsets correspond to levels of detail (LODs). In some examples, the non-overlapping subsets correspond to sub-meshes of the 3D mesh. In some examples, the non-overlapping subsets correspond to patches in a sub-mesh of the sub-meshes.

In some examples, the quantization offset corresponds to a sequence of 3D meshes including the 3D mesh. For example, the quantization offset may be associated with a subset of vertices across mesh frames of the sequence of 3D meshes, such as vertices across the mesh frames at a same LOD of a plurality of LODs.

In some examples, the quantization information further indicates a respective quantization offset associated with each subset of the non-overlapping subsets. For example, each subset may be associated with a different LOD of LODs associated with the vertices of the 3D mesh, in which case the subset of vertices includes only vertices at a first (same) LOD of the plurality of LODs, and the vertex is in the subset based on the vertex being at the first LOD.

In some embodiments, the quantization information includes an indicator indicating the quantization offset, as explained above. In some examples, the indicator may include a sign and a magnitude of the quantization offset. In some examples, the indicator selects the quantization offset from a plurality of quantization offsets. For example, the plurality of quantization offsets may be stored in list (e.g., an array or a table), which may be signaled by the encoder to the decoder. For example, the indicator may be an index into the list.

In some embodiments, the decoder receives (e.g., decodes), from the bitstream, an indication (e.g., mode indication) of whether quantization adjustment is enabled. The adjusting of the wavelet coefficient may be based on the indication of quantization adjustment being enabled.

In some examples, the mode indication may be received for each subset of the non-overlapping subset of vertices. In some examples, the mode indication may be received (and decoded) for a sequence of 3D meshes including the 3D mesh or per 3D mesh frame. Similar to the indication of the quantization offset, the one or more mode indications may be signaled per sequence of 3D mesh frames, per mesh frame, or per subset of vertices corresponding to per sub-mesh of the mesh frame/3D mesh, per patch group of the sub-mesh of the 3D mesh/mesh frame, per tile, per patch in a patch group, or per LOD. In some examples, based on the mode indication indicating no quantization adjustment, reconstruction adjuster 1102 may be disabled and operation at block 1308 would be skipped (e.g., omitted).

In some examples, where the subsets correspond to different LODs, one or more mode indications may be decoded, from the bitstream, selectively enabling the quantization adjustment for specific LODs of the LODs. For example, the one or more mode indications may comprise an index of the LOD (e.g., identifying the LOD) and a binary indication of whether the quantization adjustment operation corresponding to the LOD is enabled or disabled (e.g., skipped).

In some examples, the received quantization offsets are determined by an encoder. For example, the value of the quantization offset associated with a subset of vertices may be determined (derived/computed) from the difference between a displacement value after being wavelet transformed (lifted), before being quantized and a displacement value after being inverse quantized, before being inverse wavelet transformed (inverse-lifted), etc. In some examples, the offset value associated with a subset of vertices may be further adjusted by an offset adjustment value (a_{δ}) and/or one or more threshold values, as explained above in FIG. 10. In some examples, the offset value may be scaled with a fixed value according to the subset of vertices, e.g., an LOD or index of the LOD corresponding to the subset.

In other examples, the decoder may itself apply the offset adjustment value (a_{δ}) and/or one or more threshold values, as explained above in FIG. 10. For example, the quantization information may indicate whether the offset adjustment value (a_{δ}) and/or one or more threshold values are to be applied to the quantization offset value. The one or more thresholds may be predetermined or signaled in the quantization information. The offset adjustment value (a_{δ}) may be derived according to the LOD associated with the subset of vertices or it may be signaled in the quantization information.

Related to the encoding of the indication (e.g., mode indication) of whether quantization adjustment is enabled and/or the indication of the quantization offset described above in FIG. 12, the decoder may perform entropy decoding to decode the mode indication and/or the indication of the quantization offset from the bitstream.

At block 1306, the decoder (e.g., inverse quantizer 222 of FIG. 2A and FIG. 2B, or inverse quantizer 312 of FIG. 3) inverse quantizes the quantized wavelet coefficient to determine a wavelet coefficient. In some embodiments, to perform inverse quantization, the decoder determines an inverse quantization scaling factor (e.g., corresponding to quantization size s in FIGS. 8-10) associated with the subset. In some examples, the inverse quantization scaling factor is determined for each subset of non-overlapping subsets of the set of vertices. Then, quantized wavelet coefficients corresponding to vertices in each of the subsets may be inverse quantized according to a respective inverse quantization scaling factor associated with that subset. Then, the decoder scales the quantized wavelet coefficient based on the inverse quantization scaling factor to determine the wavelet coefficient.

In some examples, a quantized wavelet coefficient (\hat{X} representing a quantized, transformed wavelet coefficient) may be inverse quantized to determine an inverse quantized wavelet coefficient (\hat{X}based on the inverse quantization scaling factor (s_i) and a quantization offset (e.g., δ or δ′), as follows:

$$X \approx \tilde{X} = sgn ( \hat{X} ) * ( \vert \hat{X} \vert * s\_i + δ ) = sgn ( \hat{X} ) * ( ( \vert \hat{X} \vert + {δ}^{′} ) * s\_i )$$

In some examples, the inverse quantization scaling factor (s_i) may be determined by applying an offset adjustment value a_{δ} to change the value of the scaling factor (s_i) adaptively according to, e.g., the LOD level. For example, offset adjustment value a_{δ} may include a scaling factor (s_lod) or inverse scaling factor (s_lod_i). For example, s_iin LOD₀ may be multiplied by the s_lod (e.g., ½) so that the s_i value in LOD1 is equal to half of the value in LOD0.

The sgn function is a sign function (e.g., a signum function) that outputs a sign of a wavelet coefficient (\hat{X}) and the magnitude of \hat{X} is shown as the absolute function |\hat{X}|.

In some examples, the quantization offset (e.g., bias or shift) may be an offset (δ) added to an inverse-scaled quantized wavelet coefficient (|\hat{X}|*s_i).

In some examples, the quantization offset (e.g., bias or shift) may be an offset (δ′) added to the quantized wavelet coefficient before being inverse scaled ((|\hat{X}|+δ′)*s_i).

In some examples, the quantization offset (e.g., bias or shift) may be an offset (δ) adjusted according to offset adjustment value a_{δ} to change the value of the offset adaptively according to the LOD level.

In some embodiments, by shifting (e.g., adjusting) the inverse quantized wavelet coefficient, the output inverse quantized wavelet coefficient (\hat{X}) may more closely approximate the original wavelet coefficient X at the encoder.

In some examples, the inverse quantization scaling factor s_i corresponds to an inverse of quantization scaling factor s_q applied by the encoder in FIG. 12 (e.g., s_i=1/s_q). In some examples, the inverse quantization scaling factor (e.g., s_i) may be determined based on a quantization parameter (qp) and/or a bit-depth parameter (bitDepthPosition or BDP). For example, the inverse quantization scaling factor (iscale[d]) for a quantized wavelet coefficient (e.g., representing a displacement signal d) may be determined as a power of two according to the following relationship:

$$i s c a le [ d ] = qp >= 0 ? power ( 0.5 , 16 - BDP + ( 4 - qp ) / 6 ) : 0.$$

In some examples, the quantization parameter (qp) and/or the bit-depth parameter (BDP) may be determined and/or decoded (e.g., from the bitstream) for each subset of the set of vertices. In some examples, the quantization parameter and/or the bit-depth parameter may be decoded for the 3D mesh (e.g., a 3D mesh frame) or a sequence of 3D meshes (e.g., including the 3D mesh).

In some examples, the inverse quantization scaling factor may be determined as a fixed ratio between subsets (e.g., LODs) such that the inverse quantization scaling factor is scaled (e.g., increased or decreased) according to the fixed ratio per subset. In these examples, the inverse quantization scaling factor, the quantization parameter, and/or the bit-depth parameter are not signaled in the bitstream.

In some examples, a displacement may be represented as three components, in which case an inverse quantization scaling factor may be applied to each component. In typical implementations, the inverse quantization scaling factor may be determined to be the same for each component.

In some examples, the quantization information further indicates the quantization parameter and/or the bit-depth parameter associated with the subset. In some examples, the quantization information further indicates a quantization parameter or a bit-depth parameter that may be signaled for each respective subset of the non-overlapping subsets of vertices.

At block 1308, the decoder adjusts, based on the vertex being in the subset, the wavelet coefficient according to the quantization offset to determine the displacement of the vertex.

In some examples, the wavelet coefficient is adjusted based on combining (e.g., adding) the quantization offset to the wavelet coefficient to reconstruct the displacement. For example, the quantization offset may be added to a magnitude of the wavelet coefficient to reconstruct the displacement such that a sign of the wavelet coefficient is the same as a sign of the adjusted wavelet coefficient.

In some examples, the decoder may further inverse transform the wavelet coefficient (that has been inverse quantized) to reconstruct the displacement for the vertex. For example, the decoder (e.g., inverse wavelet transformer 220 of FIGS. 2A-2B, or inverse wavelet transformer 314 of FIG. 3) may apply an inverse quantizer (e.g., an inverse lifting scheme) to the inverse-quantized wavelet coefficients to determine reconstructed displacements. In some examples, the decoder may iteratively apply the inverse transform for each subset of inverse-quantized wavelet coefficients. For example, where subsets correspond to LODs, the decoder may iteratively apply the inverse transform to the inverse-quantized wavelet coefficients in each LOD according to an order of the LODs (e.g., in increasing order).

In some examples, the decoder reconstructs a geometry of the 3D mesh based on the determined displacement (and similarly determined displacement of vertices of the set of vertices of the 3D mesh). In some examples, the decoder may reconstruct the geometry based on the displacements and a base mesh. For example, the decoder may decode, from the bitstream, a base mesh associated with the 3D mesh. Then, the decoder may iteratively apply a subdivision scheme to the base mesh to generate positions of vertices of a subdivided base mesh, where each subset of the subsets is associated with an iteration of subdivision. To reconstruct the geometry of the 3D mesh, the decoder may add the displacement, of the vertex, to a position of a corresponding vertex of the subdivided base mesh. The reconstructed 3D mesh may be determined after applying determined displacements to corresponding vertices of the subdivided base mesh.

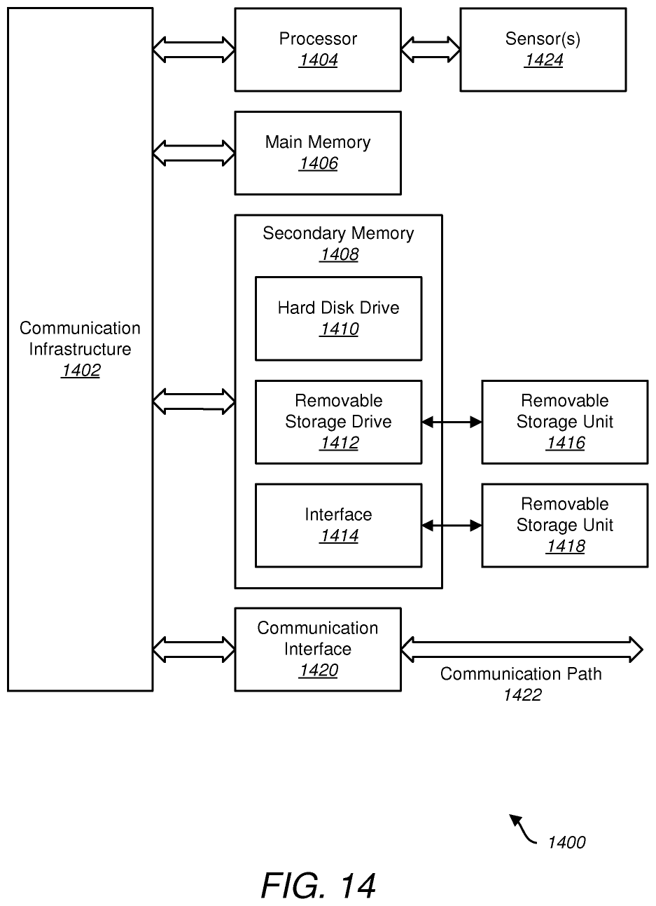

Embodiments of the present disclosure may be implemented in hardware using analog and/or digital circuits, in software, through the execution of instructions by one or more general purpose or special-purpose processors, or as a combination of hardware and software. Consequently, embodiments of the disclosure may be implemented in the environment of a computer system or other processing system. An example of such a computer system 1400 is shown in FIG. 14. Blocks depicted in the figures above, such as the blocks in FIG. 1, may execute on one or more computer systems 1400. Furthermore, each of the steps of the flowcharts depicted in this disclosure may be implemented on one or more computer systems 1400. When more than one computer system 1400 is used to implement embodiments of the present disclosure, the computer systems 1400 may be interconnected by one or more networks to form a cluster of computer systems that may act as a single pool of seamless resources. The interconnected computer systems 1400 may form a “cloud” of computers.

Computer system 1400 includes one or more processors, such as processor 1404. Processor 1404 may be, for example, a special purpose processor, general purpose processor, microprocessor, or digital signal processor. Processor 1404 may be connected to a communication infrastructure 1402 (for example, a bus or network). Computer system 1400 may also include a main memory 1406, such as random access memory (RAM), and may also include a secondary memory 1408.

Secondary memory 1408 may include, for example, a hard disk drive 1410 and/or a removable storage drive 1412, representing a magnetic tape drive, an optical disk drive, or the like. Removable storage drive 1412 may read from and/or write to a removable storage unit 1416 in a well-known manner. Removable storage unit 1416 represents a magnetic tape, optical disk, or the like, which is read by and written to by removable storage drive 1412. As will be appreciated by persons skilled in the relevant art(s), removable storage unit 1416 includes a computer usable storage medium having stored therein computer software and/or data.

In alternative implementations, secondary memory 1408 may include other similar means for allowing computer programs or other instructions to be loaded into computer system 1400. Such means may include, for example, a removable storage unit 1418 and an interface 1414. Examples of such means may include a program cartridge and cartridge interface (such as that found in video game devices), a removable memory chip (such as an EPROM or PROM) and associated socket, a thumb drive and USB port, and other removable storage units 1418 and interfaces 1414 which allow software and data to be transferred from removable storage unit 1418 to computer system 1400.

Computer system 1400 may also include a communications interface 1420. Communications interface 1420 allows software and data to be transferred between computer system 1400 and external devices. Examples of communications interface 1420 may include a modem, a network interface (such as an Ethernet card), a communications port, etc. Software and data transferred via communications interface 1420 are in the form of signals which may be electronic, electromagnetic, optical, or other signals capable of being received by communications interface 1420. These signals are provided to communications interface 1420 via a communications path 1422.

Communications path 1422 carries signals and may be implemented using wire or cable, fiber optics, a phone line, a cellular phone link, an RF link, and other communications channels.

Computer system 1400 may also include one or more sensor(s) 1424. Sensor(s) 1424 may measure or detect one or more physical quantities and convert the measured or detected physical quantities into an electrical signal in digital and/or analog form. For example, sensor(s) 1424 may include an eye tracking sensor to track the eye movement of a user. Based on the eye movement of a user, a display of a 3D mesh may be updated. In another example, sensor(s) 1424 may include a head tracking sensor to the track the head movement of a user. Based on the head movement of a user, a display of a 3D mesh may be updated. In yet another example, sensor(s) 1424 may include a camera sensor for taking photographs and/or a 3D scanning device, like a laser scanning, structured light scanning, and/or modulated light scanning device. 3D scanning devices may obtain geometry information by moving one or more laser heads, structured light, and/or modulated light cameras relative to the object or scene being scanned. The geometry information may be used to construct a 3D mesh.

As used herein, the terms “computer program medium” and “computer readable medium” are used to refer to tangible storage media, such as removable storage units 1416 and 1418 or a hard disk installed in hard disk drive 1410. These computer program products are means for providing software to computer system 1400. Computer programs (also called computer control logic) may be stored in main memory 1406 and/or secondary memory 1408. Computer programs may also be received via communications interface 1420. Such computer programs, when executed, enable the computer system 1400 to implement the present disclosure as discussed herein. In particular, the computer programs, when executed, enable processor 1404 to implement the processes of the present disclosure, such as any of the methods described herein. Accordingly, such computer programs represent controllers of the computer system 1400.

In another embodiment, features of the disclosure may be implemented in hardware using, for example, hardware components such as application-specific integrated circuits (ASICs) and gate arrays. Implementation of a hardware state machine to perform the functions described herein will also be apparent to persons skilled in the relevant art(s).

What is claimed is:

1. A method comprising:
decoding, from a bitstream, a quantized wavelet coefficient representing a displacement of a vertex in a set of vertices of a three-dimensional (3D) mesh;
decoding, from the bitstream, quantization information indicating a quantization offset associated with a subset of vertices of the set of vertices;
inverse quantizing the quantized wavelet coefficient to determine a wavelet coefficient; and
adjusting, based on the vertex being in the subset, the wavelet coefficient according to the quantization offset to determine the displacement of the vertex.

2. The method according to claim 1, wherein the set of vertices comprises non-overlapping subsets of vertices, and wherein the subset is one of the non-overlapping subsets.

3. The method according to claim 2, wherein the non-overlapping subsets correspond to levels of detail (LODs).

4. The method according to claim 2, wherein the quantization information further indicates a respective quantization offset associated with each subset of the non-overlapping subsets.

5. The method according to claim 1, wherein the quantization information comprises an indicator indicating the quantization offset.

6. The method according to claim 5, wherein the indicator selects the quantization offset from a plurality of quantization offsets that are stored in a table or a list.

7. The method according to claim 1, further comprising:
obtaining, from the bitstream, an indication of whether quantization adjustment is enabled, wherein the adjusting the wavelet coefficient is based on the indication of quantization adjustment being enabled.

8. The method according to claim 1, wherein the adjusting the wavelet coefficients comprises:
adding the quantization offset to the wavelet coefficient to reconstruct the displacement.

9. A decoder comprising:
one or more processors; and
memory storing instructions that, when executed by the one or more processors, cause the decoder to:
decode, from a bitstream, a quantized wavelet coefficient representing a displacement of a vertex in a set of vertices of a three-dimensional (3D) mesh;
decode, from the bitstream, quantization information indicating a quantization offset associated with a subset of vertices of the set of vertices;
inverse quantize the quantized wavelet coefficient to determine a wavelet coefficient; and
adjust, based on the vertex being in the subset, the wavelet coefficient according to the quantization offset to determine the displacement of the vertex.

10. The decoder according to claim 9, wherein the set of vertices comprises non-overlapping subsets of vertices, and wherein the subset is one of the non-overlapping subsets.

11. The decoder according to claim 10, wherein the non-overlapping subsets correspond to levels of detail (LODs).

12. The decoder according to claim 10, wherein the quantization information further indicates a respective quantization offset associated with each subset of the non-overlapping subsets.

13. The decoder according to claim 9, wherein the quantization information comprises an indicator indicating the quantization offset.

14. The decoder according to claim 13, wherein the indicator selects the quantization offset from a plurality of quantization offsets that are stored in a table or a list.

15. The decoder according to claim 9, wherein the memory stores further instructions that, when executed by the one or more processors, cause the decoder to:
obtain, from the bitstream, an indication of whether quantization adjustment is enabled, wherein the adjusting the wavelet coefficient is based on the indication of quantization adjustment being enabled.

16. The decoder according to claim 9, wherein the adjusting the wavelet coefficients comprises:
adding the quantization offset to the wavelet coefficient to reconstruct the displacement.

17. A non-transitory computer-readable medium comprising instructions that, when executed by one or more processors of an apparatus, cause the apparatus to:
decode, from a bitstream, a quantized wavelet coefficient representing a displacement of a vertex in a set of vertices of a three-dimensional (3D) mesh;
decode, from the bitstream, quantization information indicating a quantization offset associated with a subset of vertices of the set of vertices;
inverse quantize the quantized wavelet coefficient to determine a wavelet coefficient; and
adjust, based on the vertex being in the subset, the wavelet coefficient according to the quantization offset to determine the displacement of the vertex.

18. The non-transitory computer-readable medium according to claim 17, wherein the set of vertices comprises non-overlapping subsets of vertices, and wherein the subset is one of the non-overlapping subsets.

19. The non-transitory computer-readable medium according to claim 17, wherein the quantization information comprises an indicator indicating the quantization offset.

20. The non-transitory computer-readable medium according to claim 17, wherein the adjusting the wavelet coefficients comprises:
adding the quantization offset to the wavelet coefficient to reconstruct the displacement.
